(19) United States
(12) Patent Application Publication
(10) Pub. No.: US 2025/0119359 A1
(43) Pub. Date: Apr. 10, 2025

(54) TRANSMISSION DEVICE, RECEPTION DEVICE, TRANSMISSION METHOD, AND RECEPTION METHOD

(71) Applicant: Sony Group Corporation, Tokyo (JP)

(72) Inventors: Hiroki MATSUDA, Saitama (JP); Shinichiro TSUDA, Kanagawa (JP)

(73) Assignee: Sony Group Corporation, Tokyo (JP)

(21) Appl. No.: 18/836,020

(22) PCT Filed: Apr. 7, 2023
(86) PCT No.: PCT/JP2023/014358

§ 371 Date: Aug. 6, 2024

(30) Foreign Application Priority Data
Apr. 14, 2022 (JP) 2022-067060

(51) Int. Cl. H04L 41/16

(52) U.S. Cl. CPC H04L 41/16

(57) ABSTRACT

A transmission device, a reception device, a transmission method, and a reception method are capable of performing signal processing for both an AI/ML model and non AI/ML model. A transmission device includes circuitry configured to process a first bit sequence or symbol sequence with a first signal processing that uses an AI/ML model, generate a second bit sequence or symbol sequence from a result the first signal processing, process the first bit sequence or symbol sequence with a second signal processing that does not use an AI/ML model, generate a third bit sequence or symbol sequence from a result of the second signal processing, and select or determine whether to process the first bit sequence or symbol sequence with the first signal processing or the second signal processing. A first transmitter transmits the second bit sequence or symbol sequence or the third bit sequence or symbol sequence accordingly.

### CROSS REFERENCE TO RELATED APPLICATIONS

This application claims the benefit of Japanese Priority Patent Application JP 2022-067060 filed on Apr. 14, 2022, the entire contents of which are incorporated herein by reference.

### TECHNICAL FIELD

The present disclosure relates to a transmission device, a reception device, a transmission method, and a reception method.

### BACKGROUND ART

At present, as a next-generation mobile communication system, Beyond 5G and 6G have been studied in the 3rd Generation Partnership Project.

In the beyond 5G and 6G radio access schemes, further improvements in high enhanced mobile broadband (cMBB), massive machine type communications (mMTC), and ultra reliable and low latency communications (URLLC) are expected. In order to realize these, processing information transmitted and received by radio communication using an artificial intelligence/machine learning (AI/ML) model has been studied. For example, Non-Patent Literatures 1 and 2 have studied a technology for improving frequency utilization efficiency by performing encoding processing and decoding processing using an AI/ML model on channel status information (CSI) transmitted from a terminal device to a base station.

### CITATION LIST

### Non Patent Literature

NPL 1: RWS-210170, “Study on AI/ML based air interface enhancement in Rel-18”, VIVO, 3GPP TSG RAN Rel-18 workshop, Electronic Meeting, Jun. 28-Jul. 2, 2021 NPL 2: RWS-210373, “AI/ML enabled RAN and NR Air Interface”, Intel Corporation, 3GPP TSG RAN Rel-18 workshop, Electronic Meeting, June 28-Jul. 2, 2021

### SUMMARY

### Technical Problem

Consider a radio communication system including a transmission side that performs encoding processing using an AI/ML model on a given bit sequence or symbol sequence (hereinafter referred to as “data”), and a reception side that performs decoding processing using the AI/ML model on encoded data. In such a radio communication system, it is desirable that not only signal processing that uses the AI/ML model but also signal processing according to a related art that does not use the AI/ML model can be performed.

The present disclosure is intended to solve the above problems, and an object thereof is to provide a transmission device, a reception device, a transmission method, and a reception method capable of performing both signal processing used for an AI/ML model and signal processing that does not use the AI/ML model.

### Solution to Problem

A transmission device according to the present disclosure includes: circuitry configured to process a first bit sequence or symbol sequence with a first signal processing that uses an AI/ML model, generate a second bit sequence or symbol sequence from a result the first signal processing, process the first bit sequence or symbol sequence with a second signal processing that does not use an AI/ML model, and generate a third bit sequence or symbol sequence from a result of the second signal processing. The circuitry is further configured to select or determine whether to process the first bit sequence or symbol sequence with the first signal processing or the second signal processing, and a first transmitter is configured to transmit the second bit sequence or symbol sequence or the third bit sequence or symbol sequence according to the selection or determination.

A reception device according to the present disclosure includes: a receiver configured to receive a second bit sequence or symbol sequence or a third bit sequence or symbol sequence and circuitry configured to process the second bit sequence or symbol sequence with a first signal processing that uses an AI/ML model, restore a first bit sequence or symbol sequence from a result the first signal processing. The circuitry is further configured to process the third bit sequence or symbol sequence with a second signal processing that does not use an AI/ML model, restore the first bit sequence or symbol sequence from a result of the second signal processing, and select or determine which of the processing and restoring of the second bit sequence or symbol sequence with the first signal processing or third bit sequence or symbol sequence with the second signal processing is to be performed.

A transmission method according to the present disclosure includes: processing a first bit sequence or symbol sequence with a first signal processing that uses an AI/ML model, generating a second bit sequence or symbol sequence from a result the first signal processing, processing the first bit sequence or symbol sequence with a second signal processing that does not use an AI/ML model, generating a third bit sequence or symbol sequence from a result of the second signal processing, selecting or determine whether to process the first bit sequence or symbol sequence with the first signal processing or the second signal processing, and transmitting the second bit sequence or symbol sequence or the third bit sequence or symbol sequence according to the selection or determination.

A reception method according to the present disclosure includes: receiving a second bit sequence or symbol sequence or a third bit sequence or symbol sequence, processing the second bit sequence or symbol sequence with a first signal processing that uses an AI/ML model, restoring a first bit sequence or symbol sequence from a result the first signal processing, processing the third bit sequence or symbol sequence with a second signal processing that does not use an AI/ML model, restoring the first bit sequence or symbol sequence from a result of the second signal processing, and selecting or determining which of the processing and restoring of the second bit sequence or symbol sequence with the first signal processing or third bit sequence or symbol sequence with the second signal processing is to be performed.

### BRIEF DESCRIPTION OF DRAWINGS

FIG. 1 is a diagram illustrating a configuration of a radio communication system according to a first embodiment of the present disclosure.

FIG. 2 is a diagram illustrating a configuration of a management device.

FIG. 3 is a diagram illustrating a configuration of a base station.

FIG. 4 is a diagram illustrating a configuration of a relay station.

FIG. 5 is a diagram illustrating a configuration of a terminal device.

FIG. 6 is a block diagram illustrating detailed configurations of a terminal device and a base station.

FIG. 7 is a diagram illustrating an example of first and second control information tables.

FIG. 8A is a diagram illustrating a first example of a configuration of first and second control information tables.

FIG. 8B is a diagram illustrating a first example of the configuration of the first and second control information tables.

FIG. 8C is a diagram illustrating a first example of the configuration of the first and second control information tables.

FIG. 8D is a diagram illustrating a first example of the configuration of the first and second control information tables.

FIG. 9 is a diagram illustrating a first example of a configuration of first and second control information tables.

FIG. 10A is a diagram illustrating a first example of a configuration of first and second control information tables.

FIG. 10B is a diagram illustrating a first example of a configuration of first and second control information tables.

FIG. 11 is a diagram illustrating an example of a configuration of a first control information table including control information obtained by combining two or more types of control information.

FIG. 12 is a diagram illustrating an example of a configuration of a first control information table including two or more types of control information.

FIG. 13A is a sequence diagram illustrating details of processing of the radio communication system.

FIG. 13B is a sequence diagram illustrating details of processing of the radio communication system.

FIG. 13C is a sequence diagram illustrating details of processing of the radio communication system.

### DESCRIPTION OF EMBODIMENTS

Hereinafter, embodiments of the present disclosure will be described in detail with reference to the drawings. In the drawings, the same or corresponding elements are denoted by the same reference numerals, and detailed description thereof is omitted as appropriate.

### First Embodiment

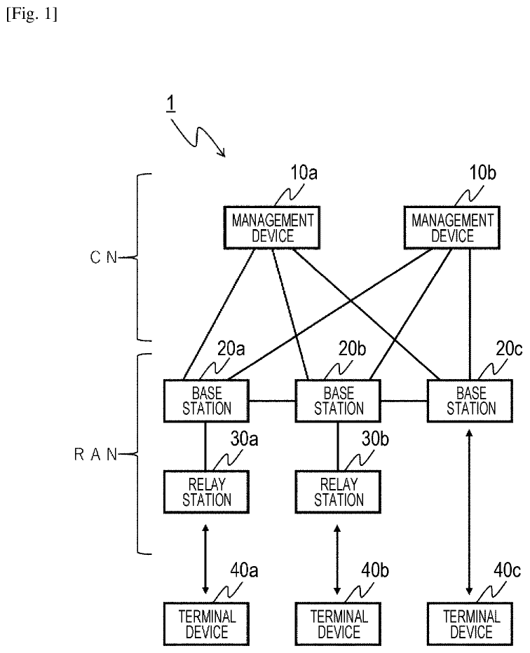

FIG. 1 is a diagram illustrating a configuration of a radio communication system 1 according to a first embodiment of the present disclosure. The radio communication system 1 includes a management device 10, a base station 20, a relay station 30, and a terminal device 40. The radio communication system 1 provides a radio network capable of mobile communication to a user by operating the radio communication devices constituting the radio communication system 1 in cooperation. The radio network of the first embodiment includes a radio access network RAN and a core network CN. In the first embodiment, the radio communication device is a device having a function of radio communication, and corresponds to the base station 20, the relay station 30, and the terminal device 40 in the example of FIG. 1.

The radio communication system 1 may include a plurality of management devices 10, a plurality of base stations 20, a plurality of relay stations 30, and a plurality of terminal devices 40. In the example of FIG. 1, the radio communication system 1 includes management devices 10a and 10b as the management devices 10, and includes base stations 20a, 20b, and 20c as the base stations 20. In addition, the radio communication system 1 includes relay stations 30a and 30b as the relay stations 30, and includes terminal devices 40a, 40b, and 40c as the terminal devices 40.

Each radio communication device in FIG. 1 may be considered as a device in a logical sense. That is, a part of each radio communication device may be realized by a virtual machine (VM), a container, a docker, or the like, and they may be implemented on physically the same hardware.

The radio communication system 1 may support a radio access technology (RAT) such as long term evolution (LTE) or new radio (NR). LTE and NR are a type of cellular radio communication technology, and enable mobile communication of the terminal device 40 by arranging a plurality of areas covered by the base station 20 in a cell shape.

The radio access scheme of the radio communication system 1 is not limited to LTE, NR, or the like, and may be another radio access scheme such as wideband code division multiple access (W-CDMA) or code division multiple access 2000 (cdma2000).

The base station 20 and the relay station 30 constituting the radio communication system 1 may be ground stations or non-ground stations. The non-ground station may be a satellite station or an aircraft station. When the non-ground station is a satellite station, the radio communication system 1 may be a bent-pipe (transparent) type mobile satellite communication system.

In the first embodiment, a ground station (also referred to as a “ground base station”) refers to a base station (“relay station”) installed on the ground. Here, the “ground” is a ground in a broad sense including not only land but also underground, water, and underwater. Note that, in the following description, the description of “ground station” may be replaced with “gateway”.

A base station in LTE may also be referred to as an evolved node B (cNodeB) or an cNB. A base station in NR may also be referred to as a gNodeB or a gNB. In LTE and NR, a terminal device (also referred to as a “mobile station” or a “terminal”) may also be referred to as user equipment (UE).

In the first embodiment, the concept of the radio communication device includes not only a portable mobile device (terminal device) such as a mobile terminal but also a device installed in a structure or a moving body.

The structure or the moving body itself may be regarded as a radio communication device. In addition, the concept of the radio communication device includes not only the terminal device 40 but also the base station 20 and the relay station 30. The radio communication device is a type of processing device or information processing device. The radio communication device can also be referred to as a transmission device or a reception device.

Hereinafter, the configuration of each radio communication device constituting the radio communication system 1 will be specifically described. Note that the configuration of each radio communication device described below is merely an example. The configuration of each radio communication device may be different from the following configuration.

### (Configuration of Management Device)

The management device 10 is a device that manages a radio network. For example, the management device 10 is a device that manages communication of the base station 20. When the core network CN is an evolved packet core (EPC), the management device 10 is, for example, a device having a function as a mobility management entity (MME). When the core network CN is a 5G core network (5GC), the management device 10 is, for example, a device having a function as an access and mobility management function (AMF) and/or a session management function (SMF). However, the functions of the management device 10 are not limited to the MME, the AMF, and the SMF. When the core network CN is 5GC, the management device 10 may be a device having a function as a network slice selection function (NSSF), an authentication server function (AUSF), or a unified data management (UDM). The management device 10 may be a device having a function as a home subscriber server (HSS).

The management device 10 may have a function of a gateway. When the core network CN is the EPC, the management device 10 may have a function as a serving gateway (S-GW) or a packet data network gateway (P-GW). When the core network CN is 5GC, the management device 10 may have a function as a user plane function (UPF). The management device 10 is not necessarily a device constituting the core network CN. When the core network CN is a core network of wideband code division multiple access (W-CDMA) or code division multiple access 2000 (cdma2000), the management device 10 may be a device that functions as a radio network controller (RNC).

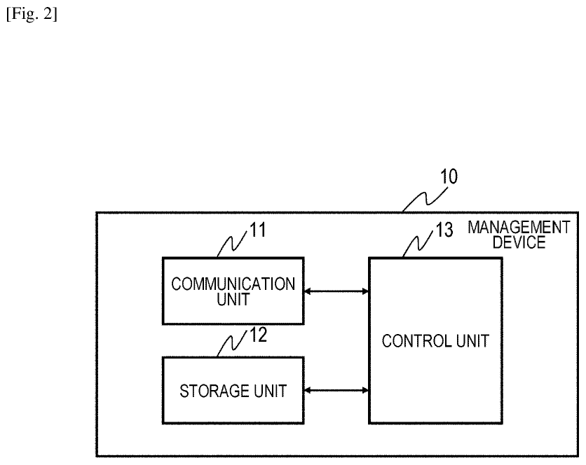

FIG. 2 is a diagram illustrating a configuration of the management device 10 according to the first embodiment. The management device 10 includes a communication unit 11, a storage unit 12, and a control unit 13. However, the configuration illustrated in FIG. 2 is a functional configuration, and the hardware configuration may be different from the functional configuration. Furthermore, the functions of the management device 10 may be statically or dynamically distributed and implemented in a plurality of physically separated configurations. The management device 10 may include a plurality of server devices.

The communication unit 11 is a communication interface for communicating with a radio communication device (for example, the base station 20 or the relay station 30). The communication unit 11 may be a network interface or a device connection interface. The communication unit 11 may be a local area network (LAN) interface such as a network interface card (NIC), a universal serial bus (USB) host controller, or a USB interface configured by a USB port or the like. The communication unit 11 may be a wired interface or a wireless interface. The communication unit 11 functions as a communication unit of the management device 10. The communication unit 11 is controlled by the control unit 13.

The storage unit 12 is a readable/writable storage device such as a dynamic random access memory (DRAM), a static random access memory (SRAM), a flash memory, or a hard disk. The storage unit 12 functions as a storage unit of the management device 10. The storage unit 12 stores, for example, a connection state of the terminal device 40. The storage unit 12 stores a radio resource control (RRC) state and an EPS connection management (ECM) state or a 5G system connection management (CM) state of the terminal device 40. The storage unit 12 may function as a home memory that stores the position information of the terminal device 40.

The control unit 13 is a controller that controls each unit of the management device 10. The control unit 13 may be realized by, for example, a processor such as a central processing unit (CPU) or a micro processing unit (MPU). Specifically, the control unit 13 may be realized by a processor executing various programs stored in a storage device inside the management device 10 using a random access memory (RAM) or the like as a work area. The control unit 13 may be realized by an integrated circuit such as an application specific integrated circuit (ASIC) or a field programmable gate array (FPGA). Any of the CPU, the MPU, the ASIC, and the FPGA can be regarded as a controller.

### (Configuration of Base Station)

The base station 20 is a radio communication device that performs radio communication with the terminal device 40. The base station 20 may wirelessly communicate with the terminal device 40 via the relay station 30, or may directly wirelessly communicate with the terminal device 40.

The base station 20 is a device corresponding to a radio base station (base station, Node B, eNB, gNB, or the like) or a radio access point. The base station 20 may be a wireless relay station. The base station 20 may be an optical extension device called a remote radio head (RRH). The base station 20 may be a reception station such as a field pickup unit (FPU). The base station 20 may be an integrated access and backhaul (IAB) donor node or an IAB relay node that provides radio access lines and radio backhaul lines in time division multiplexing, frequency division multiplexing, or space division multiplexing.

The radio access technology used by the base station 20 may be a cellular communication technology. The radio access technology used by the base station 20 may be a wireless LAN technology. The radio access technology used by the base station 20 may be a low power wide area (LPWA) communication technology.

However, the radio access technology used by the base station 20 is not limited thereto, and may be another radio access technology. The radio communication used by the base station 20 may be radio communication using millimeter waves. The radio communication used by the base station 20 may be radio communication using radio waves, or may be radio communication using infrared rays or visible light, that is, optical radio.

The base station 20 may be able to perform non-orthogonal multiple access (NOMA) communication with the terminal device 40. The NOMA communication is communication (transmission, reception, or both) using a non-orthogonal resource. The base station 20 may be able to perform NOMA communication with another base station 20.

The base station 20 may be able to communicate with the core network CN via an interface between the base station 20 and the core network CN, for example, an S1 interface. This interface may be wired or wireless. The base station 20 may be able to communicate with other base stations via an interface between base stations, for example, an X2 interface or the like. This interface may be wired or wireless.

The concept of a base station (also referred to as a “base station device”) includes not only a donor base station but also a relay base station (also referred to as a “relay station”). The concept of the base station includes not only a structure having a function of the base station but also a device installed in the structure.

The structure is, for example, a building such as a high-rise building, a house, a steel tower, a station facility, an airport facility, a harbor facility, or a stadium. The concept of a structure includes not only a building but also a construction (non-building structure) such as a tunnel, a bridge, a dam, a wall, and an iron pillar, and equipment such as a crane, a gate, and a windmill. The concept of a structure includes not only a structure on land (on the ground in a narrow sense) or in the ground, but also a structure on water such as a platform or a megafloat, and a structure under water such as an ocean observation facility. The base station may also be referred to as an information processing device.

The base station 20 may be a fixed station or a radio communication device configured to be movable, that is, a mobile station. The base station 20 may be a device installed in a moving body or may be a moving body itself. A relay station having mobility can be regarded as the base station 20 as a mobile station. A device originally having a mobile capability, such as an unmanned aerial vehicle (UAV) typified by a vehicle, a drone, or the like, and a smartphone, on which at least a part of the functions of the base station is mounted can also be regarded as the base station 20 as a mobile station.

The moving body may be a mobile terminal such as a smartphone or a mobile phone. The moving body may be a moving body (for example, a vehicle such as an automobile, a bicycle, a bus, a truck, a motorcycle, a train, or a linear motor car) that moves on land (on the ground in a narrow sense) or a moving body (for example, the subway) that moves in the ground (for example, in the tunnel).

The moving body may be a moving body (for example, a ship such as a passenger ship, a cargo ship, or a hovercraft) that moves over water or a moving body (for example, submersible ships such as submersibles, submarines, or unmanned underwater vehicles) that moves under water.

The moving body may be a moving body (for example, an aircraft such as an airplane, an airship, or a drone) that moves in the atmosphere.

The base station 20 may be a ground base station (ground station) installed on the ground. The base station 20 may be a base station arranged in a structure on the ground or may be a base station installed in a moving body moving on the ground. The base station 20 may be an antenna installed in a structure such as a building and a signal processing device connected to the antenna. The base station 20 may be a structure or a moving body itself. The “ground” is a ground in a broad sense including not only land (ground in a narrow sense) but also underground, water, and underwater. The base station 20 is not limited to a ground base station. When the radio communication system 1 is a satellite communication system, the base station 20 may be an aircraft station. From the perspective of a satellite station, an aircraft station located on the earth is a ground station.

The base station 20 is not limited to a ground station. The base station 20 may be a non-ground base station device (non-ground station) capable of floating in the air or space. The base station 20 may be an aircraft station or a satellite station.

The satellite station is a satellite station capable of floating outside the atmosphere. The satellite station may be a device mounted on a space vehicle such as an artificial satellite, or may be a space vehicle itself. A space vehicle is a moving body that moves outside the atmosphere. Examples of the space vehicle include artificial bodies such as an artificial satellite, a spacecraft, a space station, and a probe.

The satellite serving as the satellite station may be any of a low earth orbiting (LEO) satellite, a medium earth orbiting (MEO) satellite, a geostationary earth orbiting (GEO) satellite, or a highly elliptical orbiting (HEO) satellite. The satellite station may be a device mounted on a low earth orbiting satellite, a medium earth orbiting satellite, a geostationary earth orbiting satellite, or a highly elliptical orbiting satellite.

An aircraft station is a radio communication device such as an aircraft or the like capable of floating in the atmosphere. The aircraft station may be a device mounted on an aircraft or the like, or may be an aircraft itself. The concept of an aircraft includes not only heavy aircrafts such as airplanes or gliders, but also light aircrafts such as balloons or airships. The concept of an aircraft includes not only heavy or light aircrafts, but also rotorcrafts such as helicopters or autogyros. The aircraft station or the aircraft on which the aircraft station is mounted may be an unmanned aircraft such as a drone.

The concept of unmanned aircrafts also includes an unmanned aircraft system (UAS) and a tethered UAS. The concept of unmanned aircrafts includes lighter than air UAS (LTA) and heavier than air UAS (HTA). The concept of unmanned aircrafts also includes high altitude UAS platforms (HAPs).

The coverage of the base station 20 may be relatively large such as a macro cell or may be relatively small such as a pico cell. The coverage of the base station 20 may be extremely small, such as a femtocell. The base station 20 may have a beamforming function. The base station 20 may form a cell or a service area for each beam.

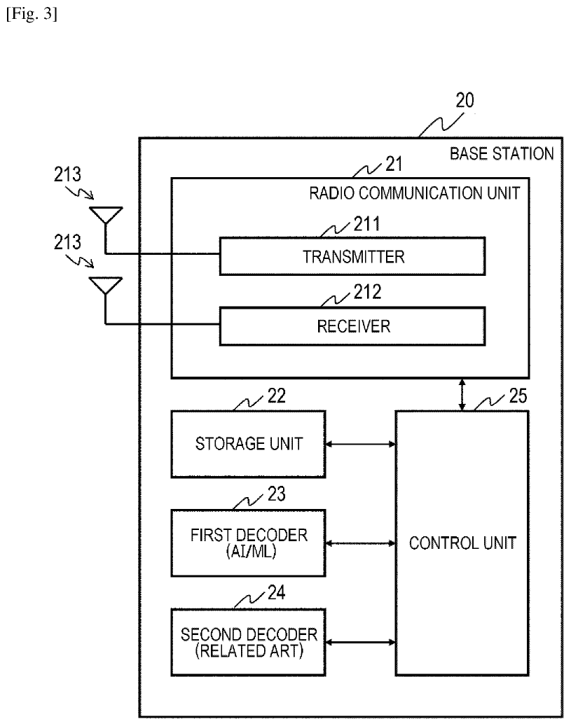

FIG. 3 is a diagram illustrating a configuration of the base station 20 according to the first embodiment. The base station 20 includes a radio communication unit 21, a storage unit 22, a first decoder 23, a second decoder 24, and a control unit 25. However, the configuration illustrated in FIG. 3 is a functional configuration, and the hardware configuration may be different from the functional configuration. Furthermore, the functions of the base station 20 may be implemented in a distributed manner in a plurality of physically separated configurations.

The radio communication unit 21 is a signal processing unit for wirelessly communicating with other radio communication devices (for example, the relay station 30, the terminal device 40, or another base station 20). The radio communication unit 21 is controlled by the control unit 25. The radio communication unit 21 corresponds to one or a plurality of radio access schemes. The radio communication unit 21 may support both NR and LTE. The radio communication unit 21 may support W-CDMA, cdma2000, and the like in addition to NR and LTE. The radio communication unit 21 may support an automatic retransmission technology such as hybrid automatic repeat request (HARQ).

The radio communication unit 21 includes a transmitter 211, a receiver 212, and an antenna 213. The radio communication unit 21 may include a plurality of transmitters 211, a plurality of receivers 212, and a plurality of antennas 213. When the radio communication unit 21 supports a plurality of radio access schemes, each unit of the radio communication unit 21 may be configured individually for each radio access scheme. The transmitter 211 and the receiver 212 may be individually configured by LTE and NR. The antenna 213 may include a plurality of antenna elements, for example, a plurality of patch antennas. The radio communication unit 21 may have a beamforming function. The radio communication unit 21 may have a polarization beamforming function using vertically polarized waves (V-polarized waves) and horizontally polarized waves (H-polarized waves).

The transmitter 211 performs processing of transmitting the downlink control information and the downlink data. As an example, first, the transmitter 211 encodes the downlink control information and the downlink data input from the control unit 24 using an encoding scheme such as block encoding, convolutional encoding, turbo encoding, or the like. As the encoding, encoding by a polar code or encoding by a low density parity check code (LDPC) may be performed.

Next, the transmitter 211 modulates the encoded bits according to a predetermined modulation scheme such as BPSK, QPSK, 16-QAM, 64-QAM, or 256-QAM. At this time, the signal points on the constellation do not necessarily have to be equidistant. That is, the constellation may be a non-uniform constellation (NUC).

Next, the transmitter 211 multiplexes the modulation symbol of each channel and the downlink reference signal and arranges the multiplexed symbols in a predetermined resource element. Next, the transmitter 211 performs various types of signal processing on the multiplexed signal. As an example, the transmitter 211 performs processing such as conversion into a frequency domain by fast Fourier transform, addition of a guard interval (cyclic prefix), generation of a baseband digital signal, conversion into an analog signal, quadrature modulation, up-conversion, removal of an extra frequency component, and power amplification. Finally, the signal generated by the transmitter 211 is transmitted from the antenna 213.

The receiver 212 processes the uplink signal received via the antenna 213. As an example, first, the receiver 212 performs down-conversion, removal of an unnecessary frequency component, control of an amplification level, quadrature demodulation, conversion to a digital signal, removal of a guard interval (cyclic prefix), extraction of a frequency domain signal by fast Fourier transform, and the like on the uplink signal.

Next, the receiver 212 separates uplink channels and uplink reference signals such as a physical uplink shared channel (PUSCH) and a physical uplink control channel (PUCCH) from the signals subjected to these processes. Next, the receiver 212 demodulates the received signal from the modulation symbol of the uplink channel according to a modulation scheme such as binary phase shift keying (BPSK) or quadrature phase shift keying (QPSK). The modulation scheme may be 16-QAM (Quadrature Amplitude Modulation), 64-QAM, 256-QAM, or the like. At this time, the signal points on the constellation do not necessarily have to be equidistant. That is, the constellation may be a non-uniform constellation.

Next, the receiver 212 performs decoding processing on the demodulated encoded bits of the uplink channel. Finally, the decoded uplink data and uplink control information are output to the control unit 24.

The antenna 213 is an antenna device that mutually converts a current and a radio wave. The antenna 213 may be configured by one antenna element, for example, one patch antenna. The antenna 213 may include a plurality of antenna elements, for example, a plurality of patch antennas. When the antenna 213 includes a plurality of antenna elements, the radio communication unit 21 may have a beamforming function. The radio communication unit 21 may be configured to generate a directional beam by controlling directivity of a radio signal using a plurality of antenna elements. The antenna 213 may be a dual-polarized antenna. When the antenna 213 is a dual-polarized antenna, the radio communication unit 21 may use vertically polarized waves (V-polarized waves) and horizontally polarized waves (H-polarized waves) when transmitting a radio signal. The radio communication unit 21 may control the directivity of the radio signal transmitted using the vertically polarized wave and the horizontally polarized wave.

The storage unit 22 is a readable/writable storage device such as a DRAM, an SRAM, a flash memory, or a hard disk. The storage unit 22 functions as a storage unit of the base station 20.

The first decoder 23 has a function of performing first signal processing that uses the AI/ML model. The AI/ML model is a neural network model obtained by machine learning or deep learning. The neural network model may be, for example, a convolutional neural network (CNN), a recurrent neural network (RNN), a long short-term memory (LSTM), or the like. The AL/ML model may be any of these models, or may be a combination of these models in series or in parallel.

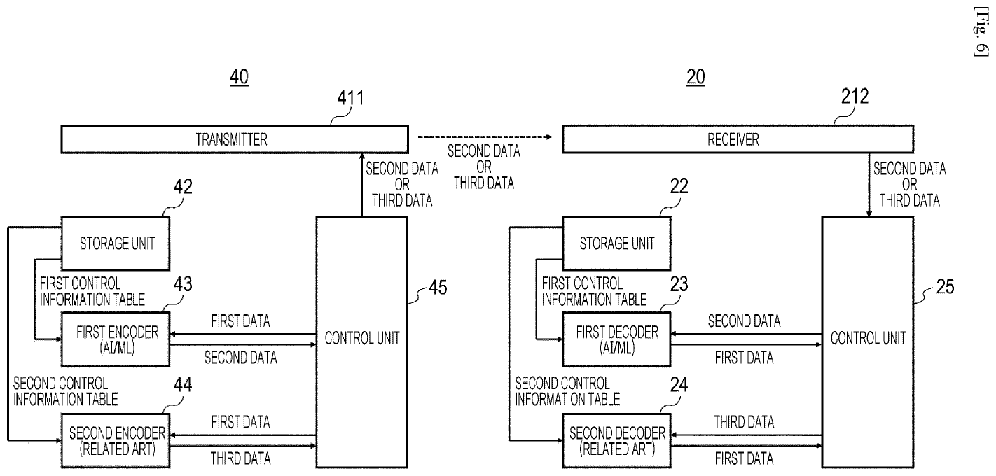

The first decoder 23 receives the second data as an input and performs first signal processing that uses the AI/ML model on the second data to restore and output the first data. The first decoder 23 may be realized by a processor such as a CPU or an MPU. The first decoder 23 may be realized by an integrated circuit such as an ASIC or an FPGA. A more detailed configuration of the first decoder 23 will be described later with reference to FIG. 6.

The second decoder 24 has a function of performing second signal processing according to the related art that does not use the AI/ML model. The second decoder 24 receives the third data as input and performs second signal processing on the third data to restore and output the first data. The second decoder 24 may be realized by a processor such as a CPU or an MPU. The second decoder 24 may be realized by an integrated circuit such as an ASIC or an FPGA. A more detailed configuration of the second decoder 24 will be described later with reference to FIG. 6.

The control unit 25 is a controller that controls each unit of the base station 20. The control unit 25 may be realized by a processor such as a CPU or an MPU. Specifically, the control unit 25 may be implemented by a processor executing various programs stored in a storage device inside the base station 20 using a RAM or the like as a work area. The control unit 25 may be realized by an integrated circuit such as an ASIC or an FPGA. The CPU, the MPU, the ASIC, and the FPGA can all be regarded as controllers. The control unit 25 may be realized by a graphics processing unit (GPU) in addition to the CPU or instead of the CPU.

Note that, in some embodiments, the base station 20 may be configured by a set of a plurality of physical or logical devices. As an example, the base station 20 in the first embodiment may be distinguished into a plurality of devices such as a baseband unit (BBU) and a radio unit (RU). The base station 20 may be interpreted as a set of the plurality of devices. In addition, the base station may be either a BBU or an RU, or may be both. The BBU and the RU may be connected by a predetermined interface, for example, an enhanced common public radio interface (eCPRI).

The RU may be referred to as a remote radio unit (RRU) or a radio DoT (RD). The RU may correspond to a gNB distributed unit (gNB-DU) described later. The BBU may correspond to a gNB central unit (gNB-CU) to be described later. The RU may be a device integrally formed with the antenna. An antenna of the base station 20, for example, an antenna integrally formed with an RU, may adopt an advanced antenna system and support MIMO or beamforming such as FD-MIMO. The antenna of the base station 20 may include, for example, 64 transmission antenna ports and 64 reception antenna ports.

The antenna mounted on the RU may be an antenna panel composed of one or more antenna elements, and the RU may be mounted with one or more antenna panels. The RU may be equipped with two types of antenna panels: a horizontally polarized antenna panel and a vertically polarized antenna panel. The RU may be equipped with two types of antenna panels: a right-handed circularly polarized antenna panel and a left-handed circularly polarized antenna panel. The RU may be controlled by forming an independent beam for each antenna panel.

A plurality of the base stations 20 may be connected to each other. The one or more base stations 20 may be included in a radio access network (RAN). At this time, the base station 20 may be simply referred to as a RAN, a RAN node, an access network (AN), an AN node, or the like. The RAN in LTE may be referred to as enhanced universal terrestrial RAN (EUTRAN). The RAN in NR may be referred to as NGRAN. The RAN in W-CDMA (UMTS) may be referred to as UTRAN.

The base station 20 in LTE may be referred to as an evolved node B (cNodeB) or an CNB. At this time, the EUTRAN includes one or more eNodeBs (cNBs).

The NR base station 20 may be referred to as a gNodeB or a gNB. At this time, the NGRAN includes one or more gNBs. The EUTRAN may include a gNB (en-gNB) connected to a core network (EPC) in an LTE communication system (EPS). The NGRAN may include an ng-eNB connected to a core network 5GC in a 5G communications system (5GS).

When the base station 20 is an eNB, a gNB, or the like, the base station 20 may be referred to as 3GPP access (3GPP Access). When the base station 20 is a radio access point, the base station 20 may be referred to as non-3GPP access (Non-3GPP Access). The base station 20 may be an optical extension device called a remote radio head (RRH). When the base station 20 is the gNB, the base station 20 may be a combination of the gNB-CU and the gNB-DU described above, or may be either the gNB-CU or the gNB-DU.

The gNB-CU hosts a plurality of upper layers (for example, RRC, SDAP, PDCP, and the like) in an access stratum for communication with the UE. The gNB-DU hosts a plurality of lower layers (for example, RLC, MAC, PHY, and the like) in an access stratum. Among the messages/information to be described later, the RRC signaling (semi-static notification) may be generated by the gNB-CU, and the MAC CE and the DCI (dynamic notification) may be generated by the gNB-DU. Alternatively, in the RRC configuration (semi-static notification), for example, some configurations such as IE: cellGroupConfig may be generated by the gNB-DU, and the remaining configurations may be generated by the gNB-CU. These configurations may be transmitted and received by an F1 interface to be described later.

The base station 20 may be configured to be able to communicate with other base stations. When the plurality of base stations 20 are eNBs or a combination of an eNB and an en-gNB, these base stations 20 may be connected by an X2 interface. When the plurality of base stations 20 are gNBs or a combination of a gn-eNB and a gNB, these base stations 20 may be connected by an Xn interface. When the plurality of base stations 20 is a combination of the gNB-CU and the gNB-DU, these base stations 20 may be connected by the above-described F1 interface. A message/information (for example, RRC signaling, MAC control element (MAC CE), DCI, or the like) to be described later may be transmitted between the plurality of base stations 20 via, for example, the X2 interface, the Xn interface, the F1 interface, or the like.

The cell provided by the base station 20 may be referred to as a serving cell. The concept of the serving cell includes a primary cell (PCell) and a secondary cell (SCell). When dual connectivity is provided to the terminal device 40, the PCell provided by the master node (MN) and 0 or one or more SCells may be referred to as a master cell group. Examples of the dual connectivity include EUTRA-EUTRA dual connectivity, EUTRA-NR dual connectivity (ENDC), EUTRA-NR dual connectivity with 5GC, NREUTRA dual connectivity (NEDC), and NR-NR dual connectivity.

The serving cell may include a PSCell (Primary Secondary Cell, or Primary SCG Cell). When the dual connectivity is provided to the terminal device 40, the PSCell provided by the secondary node (SN) and 0 or one or more SCells may be referred to as a secondary cell group (SCG). Unless specifically configured (for example, PUCCH on SCell), the physical uplink control channel (PUCCH) is transmitted by the PCell and the PSCell but not by the SCell. The radio link failure is detected by the PCell and the PSCell, but is not detected by the SCell (may not be detected). As described above, since the PCell and the PSCell play a special role in the serving cell, they are also referred to as a special cell (SpCell).

One downlink component carrier and one uplink component carrier may be associated with one cell. The system bandwidth corresponding to one cell may be divided into a plurality of bandwidth parts (BWPs). At this time, one or more BWPs may be set in the terminal device 40, and one BWP may be used as the active BWP for the terminal device 40. A radio resource that can be used by the terminal device 40, for example, a frequency band, a numerology (subcarrier spacing), or a slot format (slot configuration may be different for each cell, each component carrier, or each BWP.

### (Configuration of Relay Station)

The relay station 30 is a radio communication device serving as a relay device of the base station 20. The relay station 30 is a type of base station. The relay station 30 is a type of information processing device. The relay station 30 can also be referred to as a relay base station.

The relay station 30 may be able to perform NOMA communication with the terminal device 40. The relay station 30 relays communication between the base station 20 and the terminal device 40. The relay station 30 may be able to perform radio communication with another relay station 30 and the base station 20. The relay station 30 may be a ground station device or a non-ground station device. The relay station 30 constitutes a radio access network RAN together with the base station 20.

The relay station 30 may be a fixed device, a movable device, or a floating device. The size of the coverage of the relay station 30 is not limited to a specific size. The cell covered by the relay station 30 may be a macro cell, a micro cell, or a small cell.

The relay station 30 is not limited to a mounted device as long as the function of relay is satisfied.

The relay station 30 may be mounted on a terminal device such as a smartphone, may be mounted on an automobile, a train, a human-powered vehicle, or the like, may be mounted on a balloon, an airplane, a drone, or the like, or may be mounted on a home appliance such as a television, a game machine, an air conditioner, a refrigerator, or a lighting fixture.

The configuration of the relay station 30 may be similar to the configuration of the base station 20 described above. Similarly to the base station 20 described above, the relay station 30 may be a device installed in a moving body or may be a moving body itself. As described above, the moving body may be a mobile terminal such as a smartphone or a mobile phone. The moving body may be a moving body that moves on land (on the ground in a narrow sense) or may be a moving body that moves in the ground. The moving body may be a moving body that moves over water or may be a moving body that moves under water. The moving body may be a moving body that moves inside the atmosphere or may be a moving body that moves outside the atmosphere. The relay station 30 may be a ground station device or a non-ground station device. The relay station 30 may be an aircraft station, a satellite station, or the like. Similarly to the base station 20, the coverage of the relay station 30 may be large such as a macro cell or small such as a pico cell. The coverage of the relay station 30 may be extremely small, such as a femtocell. The relay station 30 may have a beamforming function. In the relay station 30, a cell or a service area may be formed for each beam.

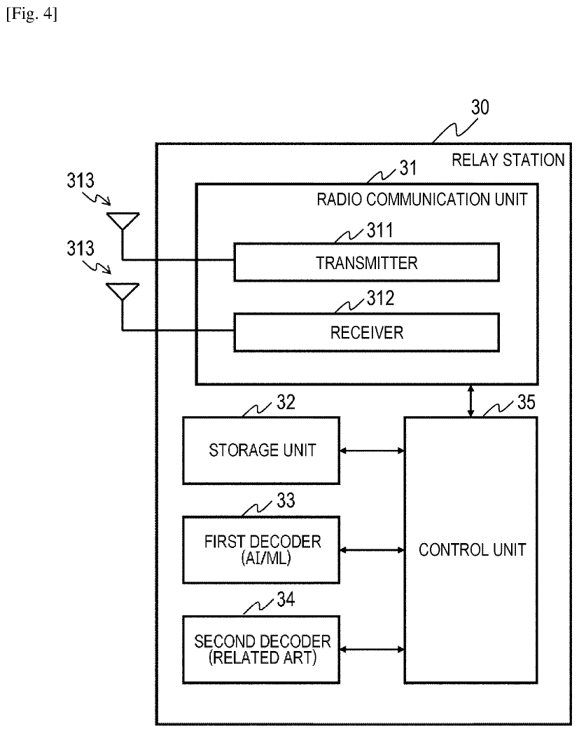

FIG. 4 is a diagram illustrating a configuration of the relay station 30 according to the first embodiment. The relay station 30 includes a radio communication unit 31, a storage unit 32, a first decoder 33, a second decoder 34, and a control unit 35. However, the configuration illustrated in FIG. 4 is a functional configuration, and the hardware configuration may be different from this. Furthermore, the functions of the relay station 30 may be implemented in a distributed manner in a plurality of physically separated configurations.

The radio communication unit 31 is a signal processing unit for wirelessly communicating with other radio communication devices (for example, the base station 20, the terminal device 40, or another relay station 30). The radio communication unit 31 corresponds to one or a plurality of radio access schemes. The radio communication unit 31 may support both NR and LTE. The radio communication unit 31 may support W-CDMA, cdma2000, and the like in addition to NR and LTE.

The radio communication unit 31 includes a transmitter 311, a receiver 312, and an antenna 313. The radio communication unit 31 may include a plurality of transmitters 311, a plurality of receivers 312, and a plurality of antennas 313. When the radio communication unit 31 supports a plurality of radio access schemes, each unit of the radio communication unit 31 may be configured individually for each radio access scheme. The transmitter 311 and the receiver 312 may be individually configured by LTE and NR. The configurations of the transmitter 311, the receiver 312, and the antenna 313 may be similar to the configurations of the transmitter 211, the receiver 212, and the antenna 213 of the base station 20 described above. The radio communication unit 31 may have a beamforming function similarly to the radio communication unit 21 of the base station 20.

The storage unit 32 is a readable/writable storage device such as a DRAM, an SRAM, a flash memory, or a hard disk. The storage unit 32 functions as a storage unit of the relay station 30.

The first decoder 33 has a function of performing first signal processing that uses the AI/ML model. The AI/ML model is a neural network model obtained by machine learning or deep learning. The neural network model may be, for example, a convolutional neural network (CNN), a recurrent neural network (RNN), a long short-term memory (LSTM), or the like. The AL/ML model may be any of these models, or may be a combination of these models in series or in parallel.

The first decoder 33 receives second data received from the terminal device 40 to be described later as an input, and performs first signal processing that uses the AI/ML model on the second data to restore and output the first data. The configuration and function of the first decoder 33 may be similar to the configuration and function of the first decoder 23 of the base station 20 described above.

The second decoder 34 has a function of performing second signal processing according to the related art that does not use the AI/ML model. The second decoder 34 receives third data received from the terminal device 40 described later as an input, performs second signal processing on the third data, and restores and outputs the first data. The configuration and function of the second decoder 34 may be similar to the configuration and function of the second decoder 24 of the base station 20 described above.

The control unit 35 is a controller that controls each unit of the relay station 30. The control unit 35 may be realized by a processor such as a CPU or an MPU. Specifically, the control unit 35 may be implemented by a processor executing various programs stored in a storage device inside the relay station 30 using a RAM or the like as a work area. The control unit 35 may be realized by an integrated circuit such as an ASIC or an FPGA. The CPU, the MPU, the ASIC, and the FPGA can all be regarded as controllers. The control unit 35 may be realized by a GPU in addition to the CPU or instead of the CPU.

Note that the relay station 30 may be an IAB relay node. The relay station 30 operates as an IAB-MT (Mobile Termination) for an IAB donor node that provides backhaul, and operates as an IAB-DU (Distributed Unit) for a terminal device 40 that provides access. The IAB donor node may be, for example, the base station 20, and operates as an IAB-CU (Central Unit).

### (Configuration of Terminal Device)

The terminal device 40 is a radio communication device that performs radio communication with another radio communication device (for example, the base station 20, the relay station 30, the another terminal device 40, or the like). The terminal device 40 may be a mobile phone, a smart device (smartphone or tablet), a personal digital assistant (PDA), a personal computer, or the like. The terminal device 40 may be a device such as a business camera having a communication function. The terminal device 40 may be a motorcycle, a moving relay vehicle, or the like on which a communication device such as a field pickup unit (FPU) is mounted. The terminal device 40 may be a machine to machine (M2M) device or an Internet of things (IoT) device.

The terminal device 40 may be able to perform NOMA communication with the base station 20. The terminal device 40 may be able to use an automatic retransmission technology such as HARQ when communicating with the base station 20.

The terminal device 40 may be able to perform sidelink communication with another terminal device 40. The terminal device 40 may be able to use an automatic retransmission technology such as HARQ when performing sidelink communication. The terminal device 40 may be able to perform NOMA communication when performing sidelink communication with another terminal device 40. The terminal device 40 may be able to perform LPWA communication with other radio communication devices such as the base station 20. The radio communication used by the terminal device 40 may be radio communication using millimeter waves. The radio communication used by the terminal device 40 may be radio communication using radio waves including sidelink communication, or may be radio communication using infrared rays or visible light, that is, optical radio.

The terminal device 40 may be a movable radio communication device, that is, a mobile device. The terminal device 40 may be a radio communication device installed in a moving body or may be a moving body itself. The terminal device 40 may be a vehicle that moves on a road, such as an automobile, a bus, a truck, or a motorcycle, or may be a radio communication device mounted on the vehicle. The moving body may be a mobile terminal, or may be a moving body that moves on land (on the ground in a narrow sense), in the ground, on water, or under water. The moving body may be a moving body that moves inside the atmosphere, such as a drone or a helicopter, or may be a moving body that moves outside the atmosphere, such as an artificial satellite.

The terminal device 40 may be able to communicate by being connected to a plurality of base stations 20 or a plurality of cells at the same time. When one base station 20 supports a communication area via a plurality of cells (for example, pCell or sCell), the plurality of cells can be bundled to communicate between the base station 20 and the terminal device 40 by a carrier aggregation (CA) technology, a dual connectivity (DC) technology, a multi-connectivity (MC) technology, or the like. Alternatively, the terminal device 40 and the plurality of base stations 20 may communicate with each other by a coordinated transmission and reception (COMP: Coordinated Multi-Point Transmission and Reception) technology through cells of the different base stations 20.

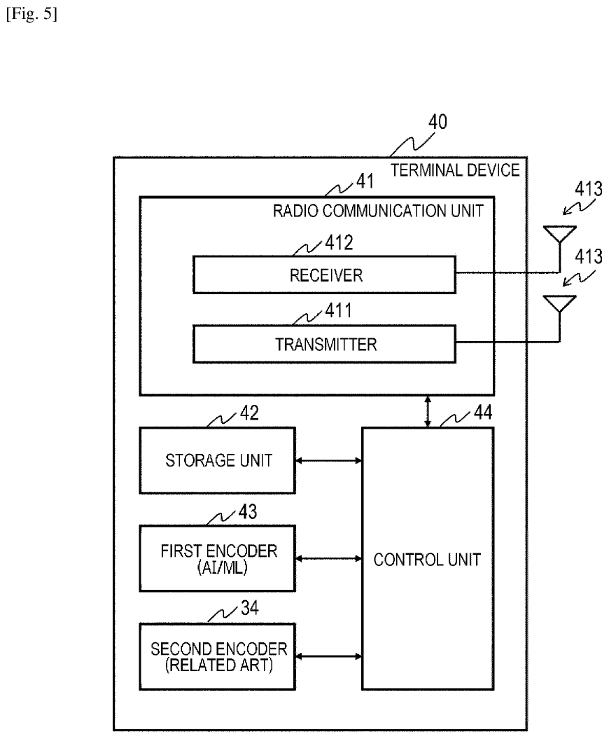

FIG. 5 is a diagram illustrating a configuration of the terminal device 40 according to the first embodiment. The terminal device 40 includes a radio communication unit 41, a storage unit 42, a first encoder 43, a second encoder 44, and a control unit 45. However, the configuration illustrated in FIG. 5 is a functional configuration, and the hardware configuration may be different from this. Furthermore, the functions of the terminal device 40 may be implemented in a distributed manner in a plurality of physically separated configurations.

The radio communication unit 41 is a signal processing unit for wirelessly communicating with other radio communication devices (for example, the base station 20, the relay station 30, or another terminal device 40). The radio communication unit 41 is controlled by the control unit 45. The radio communication unit 41 includes a transmitter 411, a receiver 412, and an antenna 413. The configurations of the radio communication unit 41, the transmitter 411, the receiver 412, and the antenna 413 may be similar to the configurations of the radio communication unit 21, the transmitter 211, the receiver 212, and the antenna 213 of the base station 20. The radio communication unit 41 may have a beamforming function similarly to the radio communication unit 21 of the base station 20.

The storage unit 42 is a readable/writable storage device such as a DRAM, an SRAM, a flash memory, or a hard disk. The storage unit 42 functions as a storage unit of the terminal device 40.

The first encoder 43 has a function of performing first signal processing that uses the AI/ML model. The AI/ML model is a neural network model obtained by machine learning or deep learning. The neural network model may be, for example, a convolutional neural network (CNN), a recurrent neural network (RNN), a long short-term memory (LSTM), or the like. The AL/ML model may be any of these models, or may be a combination of these models in series or in parallel.

The first encoder 43 generates and outputs the second data by performing first signal processing that uses the AI/ML model on the given first data as an input. The first encoder 43 may be realized by a processor such as a CPU or an MPU. The first encoder 43 may be realized by an integrated circuit such as an ASIC or an FPGA. A more detailed configuration of the first encoder 43 will be described later with reference to FIG. 6.

The second encoder 44 has a function of performing second signal processing according to the related art that does not use the AI/ML model. The second encoder 44 generates and outputs third data by performing second signal processing that does not use the AI/ML model on the given first data as an input. The second encoder 44 may be realized by a processor such as a CPU or an MPU. The second encoder 44 may be realized by an integrated circuit such as an ASIC or an FPGA. A more detailed configuration of the second encoder 44 will be described later with reference to FIG. 6.

The control unit 45 is a controller that controls each unit of the terminal device 40. The control unit 45 may be realized by a processor such as a CPU or an MPU.

Specifically, the control unit 45 may be realized by a processor executing various programs stored in a storage device inside the terminal device 40 using a RAM or the like as a work area. The control unit 45 may be realized by an integrated circuit such as an ASIC or an FPGA. The CPU, the MPU, the ASIC, and the FPGA can all be regarded as controllers. The control unit 45 may be realized by a GPU in addition to the CPU or instead of the CPU.

### (Configurations of Terminal Device on Transmission Side and Base Station on Reception Side)

In the following description, the technology according to the present disclosure will be described on the basis of an example in which an arbitrary bit sequence or symbol sequence (hereinafter referred to as “data”) is transmitted from the terminal device 40 on the transmission side to the base station 20 on the reception side. However, the relationship between the transmission side and the reception side may be switched. That is, the technology according to the present disclosure can be similarly applied to a case where data is transmitted from the base station 20 on the transmission side to the terminal device 40 on the reception side. At this time, uplink (UL) in the following description can be replaced with downlink (DL). Furthermore, the technology according to the present disclosure can be similarly applied to a case where data is transmitted from the terminal device 40 or the base station 20 on the transmission side to the relay station 30 on the reception side. Furthermore, the technology according to the present disclosure can be similarly applied to a case where data is transmitted from the relay station 30 on the transmission side to the terminal device 40 or the base station 20 on the reception side.

Furthermore, in the present disclosure, the terms encoding and decoding are concepts including any paired pieces of signal processing, and may be not only signal processing related to compression and decompression of data but also other signal processing. In the present disclosure, the terms encoding and decoding may be referred to by another term other than encoding and decoding. In the following description, terms such as encoding, encoder, decoding, and decoder are used for description, but the technology according to the present disclosure may be described using other terms.

As illustrated in FIG. 6, the radio communication system 1 according to the first embodiment includes a terminal device 40 on the transmission side and a base station 20 on the reception side.

The terminal device 40 on the transmission side includes a first encoder 43 having a function of performing first signal processing that uses the AI/ML model, and a second encoder 44 having a function of performing second signal processing according to the related art that does not use the AI/ML model.

The first encoder 43 generates second data by encoding the given first data as input by first signal processing that uses an AI/ML model. At this time, the first encoder 43 performs encoding with reference to a first control information table to be described later. The second data generated by the first encoder 43 is transmitted from the transmitter 411 to the base station 20 via the uplink.

The second encoder 44 generates third data by encoding the given first data as input by second signal processing that does not use the AI/ML model. At this time, the second encoder 44 performs encoding with reference to a second control information table to be described later. The third data generated by the second encoder 44 is transmitted from the transmitter 411 to the base station 20 via the uplink.

Note that the first signal processing and the second signal processing are exclusively performed. That is, both pieces of signal processing are not performed together, the second signal processing is not performed when the first signal processing is performed, and the first signal processing is not performed when the second signal processing is performed.

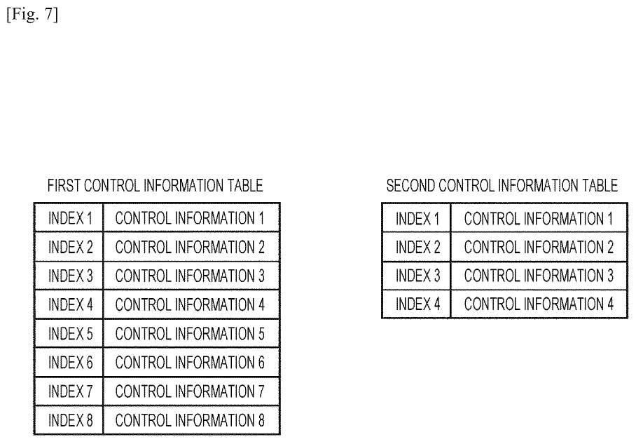

FIG. 7 is a diagram illustrating an example of the first control information table and the second control information table. The first control information table and the second control information table are tables including one or more pieces of indexed control information. The first control information table and the second control information table are generated in advance or dynamically, and the same contents are stored in the storage unit 42 of the terminal device 40 and the storage unit 22 of the base station 20.

Which one (more) of the plurality of pieces of control information included in the first control information table and the second control information table is to be referred to may be determined on the terminal device 40 side and the corresponding index may be transmitted to the base station 20, or may be determined on the base station 20 side and the corresponding index may be transmitted to the terminal device 40. In any case, the communication amount is reduced by transmitting and receiving only the corresponding index between the terminal device 40 and the base station 20 rather than directly transmitting and receiving the control information included in the first control information table and the second control information table.

The first encoder 43 of the terminal device 40 and the first decoder 23 of the base station 20 specify the control information included in the first control information table by the index. Similarly, the second encoder 44 of the terminal device 40 and the second encoder 44 of the base station 20 specify the control information included in the second control information table by the index.

Returning to FIG. 6, the control unit 45 of the mobile terminal 40 selects or determines which one of the first signal processing and the second signal processing is to be performed, and determines which one of the first encoder 43 and the second encoder 44 is to be used on the basis of the selection result or the determination result. Note that the term “select” means that there is room for selection on the terminal device 40 side as to which one of the first signal processing and the second signal processing is to be performed. On the other hand, the term “determine” means that which one of the first signal processing and the second signal processing is to be performed is determined on the basis of the notification from the base station 20, and there is no room for selection on the terminal device 40 side. The control unit 45 generates second data from the first data by the first encoder 43 when the first signal processing is selected or determined to be performed, and generates third data from the first data by the second encoder 44 when the second signal processing is selected or determined to be performed.

Further, the control unit 45 determines which one of the first control information table and the second control information table is to be referred to. In the simplest example, the control unit 45 determines to refer to the first control information table when the first signal processing is selected or determined to be performed, and determines to refer to the second control information table when the second signal processing is selected or determined to be performed.

The base station 20 on the reception side includes a first decoder 23 having a function of performing first signal processing that uses the AI/ML model, and a second decoder 24 having a function of performing second signal processing according to the related art that does not use the AI/ML model.

The first decoder 23 receives the second data transmitted from the terminal device 40 via the uplink and received by the receiver 212 as an input, and decodes the second data by first signal processing that uses the AI/ML model to restore the first data. At this time, the first decoder 23 performs decoding with reference to the above-described first control information table.

The second decoder 24 receives the third data transmitted from the terminal device 40 via the uplink and received by the receiver 212 as an input, and decodes the third data by second signal processing that does not use the AI/ML model to restore the first data. At this time, the second decoder 24 performs decoding with reference to the second control information table described above.

Note that the first signal processing and the second signal processing are exclusively performed. That is, both pieces of signal processing are not performed together, the second signal processing is not performed when the first signal processing is performed, and the first signal processing is not performed when the second signal processing is performed.

The control unit 25 of the base station 20 selects or determines which one of the first signal processing and the second signal processing is to be performed, and determines which one of the first decoder 23 and the second decoder 24 is to be used on the basis of the selection result or the determination result. Note that the term “select” means that there is room for selection on the base station 20 side as to which one of the first signal processing and the second signal processing is to be performed. On the other hand, the term “determine” means that which one of the first signal processing and the second signal processing is to be performed is determined on the basis of the notification from the terminal device 40, and there is no room for selection on the base station 20 side.

The control unit 25 selects or determines first signal processing when the second data is received from the terminal device 40, and selects or determines second signal processing when the third data is received from the terminal device 40. The control unit 25 restores the first data from the second data by the first decoder 23 when the first signal processing is selected or determined to be performed, and restores the first data from the third data by the second decoder 24 when the second signal processing is selected or determined to be performed.

Further, the control unit 25 determines which one of the first control information table and the second control information table is to be referred to. In the simplest example, the control unit 25 determines to refer to the first control information table when the first signal processing is selected or determined to be performed, and determines to refer to the second control information table when the second signal processing is selected or determined to be performed.

### (Specific Example of First Signal Processing Using AI/ML Model)

In the first embodiment, for example, the following is considered as a specific example of the first signal processing that uses the AI/ML model. However, the applicable range of the technology according to the present disclosure is not limited to the following specific examples. The technology according to the present disclosure can be applied to arbitrary signal processing that uses AI/ML.

The first signal processing that uses the AI/ML model may be signal processing of a bit sequence and/or signal processing of a symbol sequence. At this time, the AI/ML model may be a signal processing model that performs some or all functions of signal processing of a bit sequence and/or signal processing of a symbol sequence. In this case, the second signal processing may be signal processing of a bit sequence according to the related art and/or signal processing of a symbol sequence according to the related art.

The signal processing of the bit sequence may include, for example, at least one of processing such as cyclic redundancy check (CRC) assignment, error correction, rate matching, scrambling, and interleaving.

The signal processing of the symbol sequence may include at least one of, for example, QPSK/QAM modulation, multi-antenna processing, precoding processing, resource mapping processing, transform precoding processing including DFT/IDFT processing, OFDM signal processing, and the like.

The AL/ML model may be a signal processing model including functions of both bit-sequence signal processing and symbol-sequence signal processing.

The AI/ML model may be a signal processing model that newly adds a function to signal processing according to the related art. For example, the AI/ML model may be a signal processing model that adds a function of data compression or data decoding by the AI/ML model to the signal processing according to the related art. For example, the AI/ML model may be a signal processing model that inputs an operation parameter inferred on the basis of a channel status or the like to signal processing according to the related art.

### (Selection or Determination of Signal Processing Based on Capability Information)

In the first embodiment, the terminal device 40 on the transmission side may notify the base station 20 of the capability information of the first signal processing that uses the AI/ML model, and the base station 20 on the reception side may select or determine which one of the first signal processing and the second signal processing is to be performed on the basis of the capability information transmitted from the terminal device 40. The base station 20 may notify the terminal device 40 of a selection result or a determination result regarding which one of the first signal processing and the second signal processing is to be performed. For example, the following selection method or determination method is conceivable. However, the technology according to the present disclosure is not limited to the following specific examples.

The base station 20 may select or determine the first signal processing as the first signal processing when the terminal device 40 can perform the first signal processing that uses the AI/ML model, and select or determine the second signal processing according to the related art that does not use the AI/ML model as the second signal processing when the first signal processing cannot be performed.

The base station 20 may select or determine either the first signal processing or the second signal processing based on another selection method or determination method described below when the terminal device 40 can perform the first signal processing that uses the AI/ML model, and select or determine the second signal processing according to the related art that does not use the AI/ML model when the first signal processing cannot be performed.

### (Selection or Determination of Signal Processing Based on Explicit Notification)

In the first embodiment, the base station 20 on the reception side may explicitly notify the terminal device 40 of which one of the first signal processing and the second signal processing is to be performed by semi-static or dynamic control information (different from the control information included in the first control information table or the second control information table). The terminal device 40 on the transmission side may select or determine which one of the first signal processing and the second signal processing is to be performed on the basis of an explicit notification transmitted from the base station 20. For example, the following notification method is conceivable. However, the technology according to the present disclosure is not limited to the following specific examples.

The base station 20 may notify the terminal device 40 of which one of the first signal processing and the second signal processing is to be performed by system information. The terminal device 40 may select or determine which one of the first signal processing and the second signal processing is to be performed on the basis of the system information transmitted from the base station 20.

The base station 20 may notify the terminal device 40 of which one of the first signal processing and the second signal processing is to be performed by RRC signaling. The terminal device 40 may select or determine which one of the first signal processing and the second signal processing is to be performed on the basis of the RRC signaling transmitted from the base station 20.

The base station 20 may notify the terminal device 40 of which one of the first signal processing and the second signal processing is to be performed by the MAC CE. The terminal device 40 may select or determine which one of the first signal processing and the second signal processing is to be performed on the basis of the MAC CE transmitted from the base station 20.

The base station 20 may notify the terminal device 40 of which one of the first signal processing and the second signal processing is to be performed by the DCI. The terminal device 40 may select or determine which one of the first signal processing and the second signal processing is to be performed on the basis of the DCI transmitted from the base station 20.

### (Selection or Determination of Signal Processing Based on Determination Condition Determined in Advance or Dynamically)

In the first embodiment, the terminal device 40 on the transmission side may select or determine which one of the first signal processing and the second signal processing is to be performed on the basis of a determination condition (in other words, implicit notification) determined in advance or dynamically. For example, a selection method or a determination method based on the following determination conditions can be considered. However, the technology according to the present disclosure is not limited to the following specific examples.

The terminal device 40 may select or determine which one of the first signal processing and the second signal processing is to be performed according to the DCI content or the UCI content. For example, which one of the first signal processing and the second signal processing is to be performed may be selected or determined for reference signal configuration information including DMRS, CSI-RS, SRS, PT-RS, and the like, random access configuration information, modulation and coding scheme (MCS) information, precoding matrix information, PUCCH configuration information, layer mapping information, channel quality information (CQI) information, precoding matrix indicator (PMI) information, layer indicator (LI) information, and/or rank indicator (RI) information.

For example, the signal processing to be performed can be selected or determined according to the information to be transmitted, such that the first signal processing is performed when the PMI is transmitted, and the second signal processing is performed when the RI is transmitted. However, the above is merely an example, and the combination may be determined in advance or may be dynamically determined by signaling or the like. That is, it is possible to select or determine which one of the first signal processing that uses the AI/ML model and the second signal processing according to the related art is to be performed according to the DCI content or the UCI content.

The terminal device 40 may select or determine, according to the UCI format or the DCI format, which one of first signal processing and second signal processing is to be performed. For example, the first signal processing may be performed in the case of the DCI format 0_0, and the second signal processing may be performed in the case of the DCI format 0_1. For example, the first signal processing may be performed in the case of the UCI format 0, and the second signal processing may be performed in the case of the UCI format 1. For example, the first signal processing may be performed in the case of the DCI format or the UCI format having a large information amount, and the second signal processing may be performed in the case of the DCI format or the UCI format having a small information amount.

The terminal device 40 may select or determine, according to a data channel or a control channel, which one of first signal processing and second signal processing is to be performed. The data channel or the control channel includes, for example, a logical channel, a transport channel, and/or a physical channel. The logical channel includes a BCCH, a PCCH, a CCCH, a DCCH, a DTCH, and the like. The transport channel includes BCH, DL-SCH, UL-SCH, PCH, and the like. The physical channel includes a PBCH, a PDCCH, a PUCCH, a PSCCH, a PDSCH, a PUSCH, a PSSCH, a PRACH, and the like. For example, the first signal processing may be performed in the case of the PUCCH, and the second signal processing may be performed in the case of the PUSCH. Furthermore, for example, the first signal processing may be performed only in the case of a specific channel such as a PUCCH, and the second signal processing may be performed in the case of other channels.

The terminal device 40 may select or determine which one of the first signal processing and the second signal processing is to be performed according to the connection state. For example, second signal processing may be performed at the time of connection establishment such as at the time of registration processing, at the time of PDU session establishment processing, and at the time of initial connection, and first signal processing may be performed after connection establishment. Furthermore, for example, which one of the first signal processing and the second signal processing is to be performed may be selected or determined according to the RRC status.

For example, the second signal processing may be performed in the case of RRC Idle or RRC Inactive, and the first signal processing may be performed in the case of RRC Connected. Further, for example, the first signal processing may be performed only after the connection between the terminal device 40 and the base station 20 is established, and the second signal processing may be performed until the connection is established. As a result, the signal processing according to the related art that does not use the AI/ML model is performed until the connection is established, and the stability until the connection is established is improved.

The terminal device 40 may select or determine, according to the network slice, which one of first signal processing and second signal processing is to be performed. For example, first signal processing may be performed for network slice A, and second signal processing may be performed for network slice B. As a result, for example, the first signal processing that uses the AI/ML model can be performed in the case of a network slice in which relatively large capacity communication is required to improve the frequency utilization efficiency, and the second signal processing according to the related art can be performed in the case of other network slices. Further, for example, which one of the first signal processing and the second signal processing is to be performed may be selected or determined according to an identifier called single-network slice selection assistance information (S-NSSAI) allocated to the network slice.

The terminal device 40 may select or determine which one of the first signal processing and the second signal processing is to be performed according to the QoS. For example, which one of the first signal processing and the second signal processing is to be performed may be selected or determined according to QoS information such as 5QI (5G QoS identifier). As a result, for example, in the case of a QoS packet requiring relatively large capacity communication, the first signal processing that uses the AI/ML model can be performed to improve the frequency utilization efficiency, and in the case of other QoS packets, the second signal processing according to the related art can be performed.

The terminal device 40 may select or determine which one of the first signal processing and the second signal processing is to be performed according to capability of the AI/ML processing. For example, the first signal processing that uses the AI/ML model may be performed when the terminal device 40 and the base station 20 can perform the AI/ML processing, and the second signal processing according to the related art may be performed when the AI/ML processing cannot be performed.

The terminal device 40 may select or determine which one of the first signal processing and the second signal processing is to be performed according to the handover procedure. For example, the second signal processing may be performed during the handover procedure, and the first signal processing may be performed in a case other than during the handover procedure.

The terminal device 40 may select or determine which one of the first signal processing and the second signal processing is to be performed according to the learning situation of the AI/ML model. For example, the second signal processing according to the related art may be performed before the learning is performed, and the first signal processing that uses the AI/ML model may be performed after the learning is completed.

The terminal device 40 may select or determine, according to subcarrier spacing, which one of first signal processing and second signal processing is to be performed. For example, the first signal processing may be performed when the subcarrier spacing is 15 kHz, and second signal processing may be performed when the subcarrier spacing is other than 15 kHz.

The terminal device 40 may select or determine which one of first signal processing and second signal processing is to be performed according to the contention-based transmission or the non-contention-based transmission. For example, second signal processing may be performed in the case of contention-based transmission, and first signal processing may be performed in the case of non-contention-based transmission.

The terminal device 40 may select or determine, according to orthogonal multi-access signal processing or non-orthogonal multi-access signal processing, which one of first signal processing and second signal processing is to be performed. For example, the second signal processing may be performed in the case of the non-orthogonal multi-access signal processing, and the first signal processing may be performed in the case of the orthogonal multi-access signal processing. Here, the non-orthogonal multi-access signal processing may include multi-layer transmission by MIMO transmission, or may include multi-user MIMO (MU-MIMO).

The terminal device 40 may select or determine which one of the first signal processing and the second signal processing is to be performed according to the RNTI scrambling type of the DCI. For example, the first signal processing may be performed when the DCI is scrambled with the RNTI for signal processing that uses the AI/ML model, and the second signal processing may be performed when the DCI is scrambled with the RNTI for signal processing that does not use the AI/ML model.

The terminal device 40 may select or determine, according to the frequency resource or the time resource, which one of first signal processing and second signal processing is to be performed. For example, the first signal processing may be performed in the case of transmission by a predetermined BWP, and the second signal processing may be performed in the case of transmission by other BWPs. Furthermore, for example, first signal processing may be performed in the case of transmission by a predetermined resource pool, and second signal processing may be performed in the case of transmission by other resource pools. In addition, for example, second signal processing may be performed in the case of transmission by a semi-statically configured frequency resource or time resource, and first signal processing may be performed in the case of transmission by a dynamically configured frequency resource or time resource.

The terminal device 40 may select or determine which one of the first signal processing and the second signal processing is to be performed according to the frequency band. For example, the second signal processing may be performed in the case of the frequency band FR1, and the first signal processing may be performed in the case of the frequency band FR2. Furthermore, for example, the second signal processing may be performed in the case of a frequency band equal to or less than a predetermined band, and the first signal processing may be performed in the case of a frequency band of other bands.

The terminal device 40 may select or determine which one of the first signal processing and the second signal processing is to be performed according to the number of symbols included in one slot. For example, the first signal processing may be performed when the number of symbols included in one slot is more than N symbols, and the second signal processing may be performed when the number of symbols included in one slot is less than N symbols.

The terminal device 40 may select or determine, according to a dynamically configured (Dynamic Grant) transmission resource or a semi-statically configured (Configured Grant) transmission resource, which one of first signal processing and second signal processing is to be performed. For example, second signal processing may be performed in the case of transmission by semi-statically configured transmission resources, and first signal processing may be performed in the case of transmission by dynamically configured transmission resources.

The terminal device 40 may select or determine which one of the first signal processing and the second signal processing is to be performed according to the 2-step RACH or the 4-step RACH. For example, the second signal processing may be performed in the case of the 2-step RACH, and the first signal processing may be performed in the case of the 4-step RACH.

The terminal device 40 may select or determine which one of the first signal processing and the second signal processing is to be performed by combining a plurality of the determination conditions determined in advance or dynamically.

In addition, the terminal device 40 may select or determine which one of the first signal processing and the second signal processing is to be performed by combining the above-described determination condition determined in advance or dynamically and the above-described signal processing selection method or determination method based on the explicit notification.

### (Specific Example of Contents of Control Information Table)

In the first embodiment, the first control information table and the second control information table may be tables including, for example, reference signal configuration information such as DMRS, CSI-RS, SRS, and PT-RS, random access configuration information, modulation and coding scheme (MCS) information, precoding matrix information, PUCCH configuration information, layer mapping information, channel quality information (CQI) information, precoding matrix indicator (PMI) information, layer indicator (LI) information, and/or rank indicator (RI) information. However, the applicable range of the technology according to the present disclosure is not limited to such a specific example. The technology according to the present disclosure can be applied to arbitrary information provided as prior information or control information such as a standard.

Furthermore, at the time of the first signal processing that uses the AI/ML model, a part or all of the first control information table referred to by the first encoder 43 may be dynamically generated at the time of learning the AI/ML model. For example, a part or all of the first control information table may be set to a reserved value such as Reserved or a dynamic setting value such as Flexible as a parameter generated at the time of learning the AI/ML model, and the parameter may be dynamically generated at the time of learning the AI/ML model. In addition, the size of the first control information table, that is, the total number of indexes may be determined in advance or may be dynamically determined.

### (Determination of Control Information Table Based on Capability Information)

In the first embodiment, the base station 20 on the reception side may notify the terminal device 40 of the capability information of the first signal processing that uses the AI/ML model, and the terminal device 40 on the transmission side may determine which one of the first control information table and the second control information table is to be referred to on the basis of the capability information received from the base station 20. For example, the following determination method is conceivable. However, the technology according to the present disclosure is not limited to the following specific examples.

The terminal device 40 may determine to refer to the first control information table when the first signal processing that uses the AI/ML model can be performed, and may determine to refer to the second control information table when the first signal processing cannot be performed.

The terminal device 40 may determine which one of the first control information table and the second control information table is to be referred to on the basis of another determination method described below when the first signal processing that uses the AI/ML model can be performed, and may determine to refer to the second control information table when the first signal processing cannot be performed.

In the above two specific examples, when the first signal processing cannot be performed, the terminal device 40 may not configure the first control information table. Further, the terminal device 40 may always refer to the second control information table without determining which one of the first control information table and the second control information table is to be referred to.

### (Determination of Control Information Table Based on Explicit Notification)

In the first embodiment, the base station 20 on the reception side may explicitly notify the terminal device 40 of which one of the first control information table and the second control information table is to be to referred to by semi-static or dynamic control information (different from the control information included in the first control information table or the second control information table). The terminal device 40 on the transmission side may determine which one of the first control information table and the second control information table is to be referred to on the basis of an explicit notification transmitted from the base station 20. For example, the following notification method is conceivable. However, the technology according to the present disclosure is not limited to the following specific examples.

The base station 20 may notify the terminal device 40 of which one of the first control information table and the second control information table is to be referred to by system information. The terminal device 40 may determine which one of the first control information table and the second control information table is to be referred to on the basis of the system information transmitted from the base station 20.

The base station 20 may notify the terminal device 40 of which one of the first control information table and the second control information table is to be referred to by RRC signaling. The terminal device 40 may determine which one of the first control information table and the second control information table is to be referred to on the basis of the RRC signaling transmitted from the base station 20.

The base station 20 may notify the terminal device 40 of which one of the first control information table and the second control information table is to be referred to by the MAC CE. The terminal device 40 may determine which one of the first control information table and the second control information table is to be referred to on the basis of the MAC CE transmitted from the base station 20.

The base station 20 may notify the terminal device 40 of which one of the first control information table and the second control information table is to be referred to by the DCI. The terminal device 40 may determine which one of the first control information table and the second control information table is to be referred to on the basis of the DCI transmitted from the base station 20.

### (Determination of Control Information Table Based on Determination Condition Determined in Advance or Dynamically)

In the first embodiment, the terminal device 40 on the transmission side may determine which one of the first control information table and the second control information table is to be referred to on the basis of a determination condition (in other words, implicit notification) determined in advance or dynamically. For example, a determination method based on the following determination conditions can be considered. However, the technology according to the present disclosure is not limited to the following specific examples.

The terminal device 40 may determine which one of the first control information table and the second control information table is to be referred to according to the DCI content or the UCI content (type of control information). For example, which one of the first control information table and the second control information table is to be referred to may be determined for reference signal configuration information including DMRS, CSI-RS, SRS, PT-RS, and the like, random access configuration information, modulation and coding scheme (MCS) information, precoding matrix information, PUCCH configuration information, layer mapping information, channel quality information (CQI) information, precoding matrix indicator (PMI) information, layer indicator (LI) information, rank indicator (RI) information, and/or the like.

For example, the control information table to be referred to can be determined according to the information to be transmitted such that the first control information table is referred to when the PMI is transmitted, and the second control information table is referred to when the RI is transmitted. However, the above is merely an example, and the combination may be determined in advance or may be dynamically determined by signaling or the like. That is, which one of the first control information table and the second control information table is to be referred to may be determined according to the DCI content or the UCI content.

The terminal device 40 may determine which one of the first control information table and the second control information table is to be referred to according to the UCI format or the DCI format. For example, the first control information table may be referred to in the case of the DCI format 0_0, and the second control information table may be referred to in the case of the DCI format 0_1. For example, the first control information table may be referred to in the case of the UCI format 0, and the second control information table may be referred to in the case of the UCI format 1. For example, the first control information table may be referred to in the case of the DCI format or the UCI format having a large information amount, and the second control information table may be referred to in the case of the DCI format or the UCI format having a small information amount.

The terminal device 40 may determine which one of the first control information table and the second control information table is to be referred to according to the data channel or the control channel. The data channel or the control channel includes, for example, a logical channel, a transport channel, and/or a physical channel. The logical channel includes a BCCH, a PCCH, a CCCH, a DCCH, a DTCH, and the like. The transport channel includes BCH, DL-SCH, UL-SCH, PCH, and the like. The physical channel includes a PBCH, a PDCCH, a PUCCH, a PSCCH, a PDSCH, a PUSCH, a PSSCH, a PRACH, and the like. For example, the first control information table may be referred to in the case of the PUCCH, and the second control information table may be referred to in the case of the PUSCH. Further, for example, the first control information table may be referred to only in the case of a specific channel such as a PUCCH, and the second control information table may be referred to in the case of other channels.

The terminal device 40 may determine which one of the first control information table and the second control information table is to be referred to according to the connection state. For example, the second control information table may be referred to at the time of connection establishment such as at the time of registration processing, at the time of PDU session establishment processing, and at the time of initial connection, and the first control information table may be referred to after connection establishment. For example, which one of the first control information table and the second control information table is to be referred to may be determined according to the RRC Status. For example, the second control information table may be referred to in the case of RRC Idle or RRC Inactive, and the first control information table may be referred to in the case of RRC Connected. Further, for example, the first control information table may be referred to only after the connection between the terminal device 40 and the base station 20 is established, and the second control information table may be referred to until the connection is established. As a result, the control information table according to the related art that does not use the AI/ML model is referred to until the connection is established, and the stability until the connection is established is improved.

The terminal device 40 may determine which one of the first control information table and the second control information table is to be referred to according to the network slice. For example, the first control information table may be referred to in the case of the network slice A, and the second control information table may be referred to in the case of the network slice B. As a result, for example, the first control information table used in the AI/ML model can be referred to in the case of a network slice in which relatively large capacity communication is required to improve the frequency utilization efficiency, and the second control information table according to the related art can be referred to in the case of other network slices. In addition, for example, which one of the first control information table and the second control information table is to be referred to may be determined according to an identifier called single-network slice selection assistance information (S-NSSAI) allocated to the network slice.

The terminal device 40 may determine which one of the first control information table and the second control information table is to be referred to according to the QoS. For example, which one of the first control information table and the second control information table is to be referred to may be determined according to QoS information such as 5QI (5G QoS identifier). As a result, for example, the first control information table used in the AI/ML model can be referred to in the case of a QoS packet for which relatively large capacity communication is required to improve the frequency utilization efficiency, and the second control information table according to the related art can be referred in the case of other QoS packets.

The terminal device 40 may determine which one of the first control information table and the second control information table is to be referred to according to the capability of the AI/ML processing. For example, the first control information table used in the AI/ML model may be referred to when the terminal device 40 and the base station 20 can perform the AI/ML processing, and the second control information table according to the related art may be referred to when the AI/ML processing cannot be performed.

The terminal device 40 may determine which one of the first control information table and the second control information table is to be referred to according to the handover procedure. For example, the second control information table may be referred to when the handover procedure is being performed, and the first control information table may be referred to when the handover procedure is not being performed.

The terminal device 40 may determine which one of the first control information table and the second control information table is to be referred to according to the learning situation of the AI/ML model. For example, the second control information table according to the related art may be referred to before the learning is performed, and the first control information table used in the AI/ML model may be referred to after the learning is completed.

The terminal device 40 may determine which one of the first control information table and the second control information table is to be referred to according to subcarrier spacing. For example, when the subcarrier spacing is 15 kHz, the first control information table may be referred to, and when the subcarrier spacing is other than 15 kHz, the second control information table may be referred to.

The terminal device 40 may determine which one of the first control information table and the second control information table is to be referred to according to the contention-based transmission or the non-contention-based transmission. For example, the second control information table may be referred to in the case of contention-based transmission, and the first control information table may be referred to in the case of non-contention-based transmission.

The terminal device 40 may determine which one of the first control information table and the second control information table is to be referred to according to the orthogonal multi-access signal processing or the non-orthogonal multi-access signal processing. For example, the second control information table may be referred to in the case of non-orthogonal multi-access signal processing, and the first control information table may be referred to in the case of orthogonal multi-access signal processing. Here, the non-orthogonal multi-access signal processing may include multi-layer transmission by MIMO transmission, or may include multi-user MIMO (MU-MIMO).

The terminal device 40 may determine which one of the first control information table and the second control information table is to be referred to according to the RNTI scrambling type of the DCI. For example, the first control information table may be referred to when the DCI is scrambled with the RNTI for signal processing that uses the AI/ML model, and the second control information table may be referred to when the DCI is scrambled with the RNTI for signal processing that does not use the AI/ML model.

The terminal device 40 may determine which one of the first control information table and the second control information table is to be referred to according to the frequency resource or the time resource. For example, the first control information table may be referred to in the case of transmission by a predetermined BWP, and the second control information table may be referred to in the case of transmission by other BWPs. Furthermore, for example, the first control information table may be referred to in the case of transmission by a predetermined resource pool, and the second control information table may be referred to in the case of transmission by other resource pools. Further, for example, the second control information table may be referred to in the case of transmission by a semi-statically configured frequency resource or time resource, and the first control information table may be referred to in the case of transmission by a dynamically configured frequency resource or time resource.

The terminal device 40 may determine which one of the first control information table and the second control information table is to be referred to according to the frequency band. For example, the second control information table may be referred to in the case of the frequency band FR1, and the first control information table may be referred to in the case of the frequency band FR2. For example, the second control information table may be referred to in the case of a frequency band equal to or less than a predetermined band, and the first control information table may be referred to in the case of a frequency band of other bands.

The terminal device 40 may determine which one of the first control information table and the second control information table is to be referred to according to the number of symbols included in one slot. For example, the first control information table may be referred to when the number of symbols included in one slot is more than N symbols, and the second control information table may be referred to when the number of symbols included in one slot is less than N symbols.

The terminal device 40 may determine which one of the first control information table and the second control information table is to be referred to according to a dynamically configured (Dynamic Grant) transmission resource or a semi-statically configured (Configured Grant) transmission resource. For example, the second control information table may be referred to in the case of transmission by a semi-statically configured transmission resource, and the first control information table may be referred to in the case of transmission by a dynamically configured transmission resource.

The terminal device 40 may determine which one of the first control information table and the second control information table is to be referred to according to the 2-step RACH or the 4-step RACH. For example, the second control information table may be referred to in the case of the 2-step RACH, and the first control information table may be referred to in the case of the 4-step RACH.

The terminal device 40 may determine which one of the first control information table and the second control information table is to be referred to by combining a plurality of determination conditions determined in advance or dynamically. In addition, the terminal device 40 may determine which one of the first control information table and the second control information table is to be referred to by combining the above-described determination condition determined in advance or dynamically and the above-described signal processing selection method or determination method based on the explicit notification.

### (Configuration of First Control Information Table)

In the first embodiment, the first control information table may be configured as a control information table different from the second control information table. In this case, the terminal device 40 and the base station 20 may store the first control information table and the second control information table as different tables.

The first control information table may have a configuration in which control information is added to the second control information table. In this case, the first control information table may be configured as a single table, or may be configured by a table including additional control information and a reference to the second control information table.

The first control information table may be configured to include the same content as the second control information table.

The first control information table may be configured to include a plurality of control information tables.

### (Plurality of Control Information Tables Included in First Control Information Table)

In the first embodiment, the first control information table is configured to include a plurality of control information tables, and the terminal device 40 may switch and refer to the plurality of control information tables. In this case, one of the plurality of control information tables may be a default control information table. For example, when there is no explicit notification from the base station 20, the terminal device 40 may refer to the default control information table. In addition, for example, the control information table may be switched to the default control information table when a communication error occurs such as when uplink synchronization fails or when a radio link fails, or when handover or initial connection occurs. For example, the default control information table may be referred to in the initial state.

### (Switching of Plurality of Control Information Tables Based on Explicit Notification)

In the first embodiment, the base station 20 on the reception side may explicitly notify the terminal device 40 of which one of the plurality of control information tables included in the first control information table is to be referred to by semi-static or dynamic control information (different from the control information included in the first control information table or the second control information table). The terminal device 40 on the transmission side may determine which one of a plurality of control information tables included in the first control information table is to be referred to on the basis of the explicit notification transmitted from the base station 20. For example, the following notification method is conceivable. However, the technology according to the present disclosure is not limited to the following specific examples.

The base station 20 may notify the terminal device 40 of which one of a plurality of control information tables included in the first control information table is to be referred to by system information. The terminal device 40 may determine which one of a plurality of control information tables included in the first control information table is to be referred to on the basis of the system information transmitted from the base station 20.

The base station 20 may notify the terminal device 40 of which one of the plurality of control information tables included in the first control information table is to be referred to by RRC signaling. The terminal device 40 may determine which one of a plurality of control information tables included in the first control information table is to be referred to on the basis of the RRC signaling transmitted from the base station 20.

The base station 20 may notify the terminal device 40 of which one of the plurality of control information tables included in the first control information table is to be referred to by the MAC CE. The terminal device 40 may determine which one of a plurality of control information tables included in the first control information table is to be referred to on the basis of the MAC CE transmitted from the base station 20.

The base station 20 may notify the terminal device 40 of which one of the plurality of control information tables included in the first control information table is to be referred to by the DCI. The terminal device 40 may determine which one of a plurality of control information tables included in the first control information table is to be referred to on the basis of the DCI transmitted from the base station 20.

### (Switching of Plurality of Control Information Tables Based on Determination Condition Determined in Advance or Dynamically)

In the first embodiment, the terminal device 40 on the transmission side may determine which one of the plurality of control information tables included in the first control information table is to be referred to on the basis of a determination condition (in other words, implicit notification) determined in advance or dynamically. For example, a determination method based on the following determination conditions can be considered. However, the technology according to the present disclosure is not limited to the following specific examples.

The terminal device 40 may determine which one of the plurality of control information tables included in the first control information table is to be referred to according to the UCI format or the DCI format. For example, the control information table A included in the first control information table may be referred to in the case of the DCI format 0_0, and the control information table B included in the first control information table may be referred to in the case of the DCI format 0_1. Further, for example, the control information table A included in the first control information table may be referred to in the case of the UCI format 0, and the control information table B included in the first control information table may be referred to in the case of the UCI format 1.

The terminal device 40 may determine which one of a plurality of control information tables included in the first control information table is to be referred to according to the data channel or the control channel. The data channel or the control channel includes, for example, a logical channel, a transport channel, and/or a physical channel. The logical channel includes a BCCH, a PCCH, a CCCH, a DCCH, a DTCH, and the like. The transport channel includes BCH, DL-SCH, UL-SCH, PCH, and the like. The physical channel includes a PBCH, a PDCCH, a PUCCH, a PSCCH, a PDSCH, a PUSCH, a PSSCH, a PRACH, and the like. For example, the control information table A included in the first control information table may be referred to in the case of the PUCCH, and the control information table B included in the first control information table may be referred to in the case of the PUSCH.

The terminal device 40 may determine which one of a plurality of control information tables included in the first control information table is to be referred to according to the connection state. For example, the control information table A included in the first control information table may be referred to at the time of connection establishment such as at the time of registration processing, at the time of PDU session establishment processing, and at the time of initial connection, and the control information table B included in the first control information table may be referred to after connection establishment. Further, for example, which one of the plurality of control information tables included in the first control information table is to be referred to may be determined according to the RRC Status. For example, the control information table A included in the first control information table may be referred to in the case of RRC Idle or RRC Inactive, and the control information table B included in the first control information table may be referred to in the case of RRC Connected.

The terminal device 40 may determine which one of a plurality of control information tables included in the first control information table is to be referred to according to the network slice. For example, the control information table A included in the first control information table may be referred to in the case of the network slice A, and the control information table B included in the first control information table may be referred to in the case of the network slice B. In addition, for example, which one of a plurality of control information tables included in the first control information table is to be referred to may be determined according to an identifier called single-network slice selection assistance information (S-NSSAI) allocated to a network slice.

The terminal device 40 may determine which one of a plurality of control information tables included in the first control information table is to be referred to according to the QoS. For example, which one of a plurality of control information tables included in the first control information table is to be referred to may be determined according to QoS information such as 5QI (5G QoS identifier). For example, the control information table A included in the first control information table may be referred to in the case of a QoS packet requiring relatively large capacity communication, and the control information table B included in the first control information table may be referred to in the case of other QoS packets.

The terminal device 40 may determine which one of a plurality of control information tables included in the first control information table is to be referred to according to the handover procedure. For example, the control information table A included in the first control information table may be referred to when the handover procedure is being performed, and the control information table B included in the first control information table may be referred to when the handover procedure is not being performed.

The terminal device 40 may determine which one of a plurality of control information tables included in the first control information table is to be referred to according to the learning situation of the AI/ML model. For example, the control information table A included in the first control information table may be switched to the control information table B according to the degree of progress of learning.

The terminal device 40 may determine which one of the plurality of control information tables included in the first control information table is to be referred to according to the subcarrier spacing. For example, the control information table A included in the first control information table may be referred to when the subcarrier spacing is 15 kHz, and the control information table B included in the first control information table may be referred to when the subcarrier spacing is other than 15 KHz.

The terminal device 40 may determine which one of the plurality of control information tables included in the first control information table is to be referred to according to the contention-based transmission or the non-contention-based transmission. For example, the control information table A included in the first control information table may be referred to in the case of the contention-based transmission, and the control information table B included in the first control information table may be referred to in the case of the non-contention-based transmission.

The terminal device 40 may determine which one of the plurality of control information tables included in the first control information table is to be referred to according to the orthogonal multi-access signal processing or the non-orthogonal multi-access signal processing. For example, the control information table A included in the first control information table may be referred to in the case of the non-orthogonal multi-access signal processing, and the control information table B included in the first control information table may be referred to in the case of the orthogonal multi-access signal processing. Here, the non-orthogonal multi-access signal processing may include multi-layer transmission by MIMO transmission, or may include multi-user MIMO (MU-MIMO).

The terminal device 40 may determine which one of a plurality of control information tables included in the first control information table is to be referred to according to the frequency resource or the time resource. For example, the control information table A included in the first control information table may be referred to in the case of transmission by a predetermined BWP. Further, for example, the control information table A included in the first control information table may be referred to in the case of transmission by a predetermined resource pool. For example, the control information table A included in the first control information table may be referred to in the case of the transmission using the frequency resource or the time resource set semi-statically, and the control information table B included in the first control information table may be referred to in the case of the transmission using the frequency resource or the time resource set dynamically.

The terminal device 40 may determine which one of a plurality of control information tables included in the first control information table is to be referred to according to the frequency band. For example, the control information table A included in the first control information table may be referred to in the case of the frequency band FR1, and the control information table B included in the first control information table may be referred to in the case of the frequency band FR2. In addition, for example, the control information table A included in the first control information table may be referred to in the case of a frequency band equal to or less than a predetermined band, and the control information table B included in the first control information table may be referred to in the case of a frequency band of other bands.

The terminal device 40 may determine which one of a plurality of control information tables included in the first control information table is to be referred to according to the number of symbols included in one slot. For example, the control information table A included in the first control information table may be referred to when the number of symbols included in one slot is more than N symbols, and the control information table B included in the first control information table may be referred to when the number of symbols included in one slot is less than N symbols.

The terminal device 40 may determine which one of a plurality of control information tables included in the first control information table is to be referred to according to a dynamically configured (Dynamic Grant) transmission resource or a semi-statically configured (Configured Grant) transmission resource. For example, the control information table A included in the first control information table may be referred to in the case of transmission by semi-statically configured transmission resources, and the control information table B included in the first control information table may be referred to in the case of transmission by dynamically configured transmission resources.

The terminal device 40 may determine which one of a plurality of control information tables included in the first control information table is to be referred to according to the 2-step RACH or the 4-step RACH. For example, the control information table A included in the first control information table may be referred to in the case of the 2-step RACH, and the control information table B included in the first control information table may be referred to in the case of the 4-step RACH.

The terminal device 40 may determine which one of a plurality of control information tables included in the first control information table is to be referred to by combining a plurality of determination conditions determined in advance or dynamically. In addition, the terminal device 40 may determine which one of the plurality of control information tables included in the first control information table is to be referred to by combining the determination condition determined in advance or dynamically and the signal processing selection method or determination method based on the explicit notification described above.

After notifying the terminal device 40 of which one of the plurality of control information tables included in the first control information table is to be referred to, the base station 20 may dynamically notify the terminal device 40 of the index or the like included in the control information table as another control information. For example, after the control information table (for example, the control information table including the index 1 to 8 and the corresponding control information 1 to 8) to be referred to is notified from the base station 20 to the terminal device 40, the index in the control information table is notified in another control information transmitted from the base station 20 to the terminal device 40 (for example, the index 4 in the control information table is notified, and the control information 4 corresponding to the index 4 is used in the signal processing or the measurement result corresponding to the index 4 is notified). In this case, the other control information may be, for example, MAC CE, DCI, or the like.

Alternatively, the index or the like included in the control information table may be dynamically notified as another control information from the terminal device 40 to the base station 20. For example, after the control information table (for example, the control information table including the index 1 to 8 and the corresponding control information 1 to 8) to be referred to is notified from the base station 20 to the terminal device 40, the index in the control information table is notified in another control information transmitted from the terminal device 40 to the base station 20 (for example, the index 4 in the control information table is notified, and the control information corresponding to the index 4 is used in the signal processing or the measurement result corresponding to the index 4 is notified). In this case, the other control information may be, for example, MAC CE, UCI, or the like.

### (Example of Configuration of Control Information Table)

In the following description, the first control information table is referred to in the first signal processing that uses the AI/ML model, and the second control information table is referred to in the second signal processing that does not use the AI/ML model. The following specific examples may be combined.

### First Example

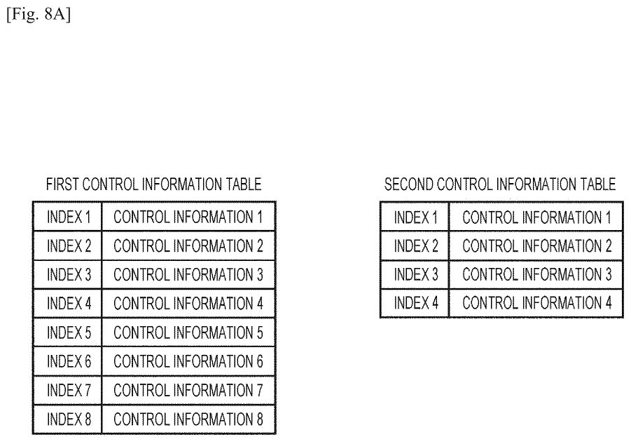

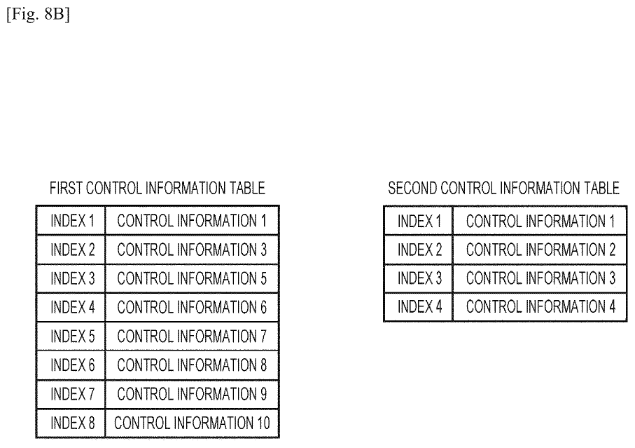

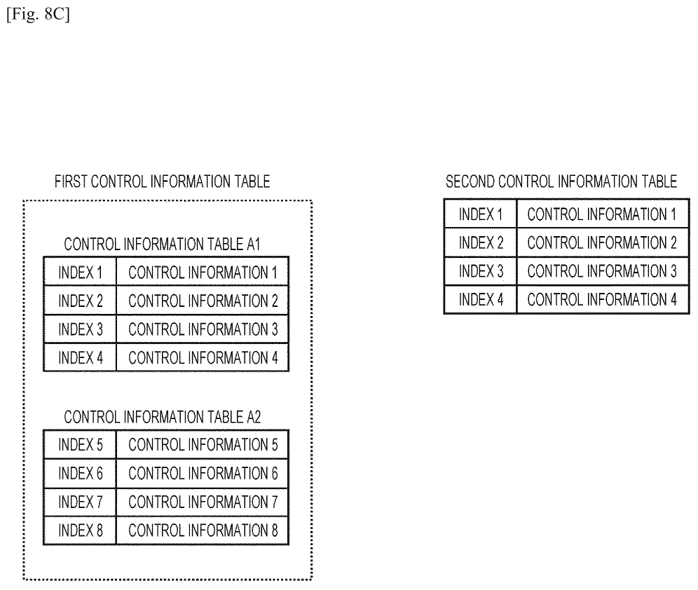

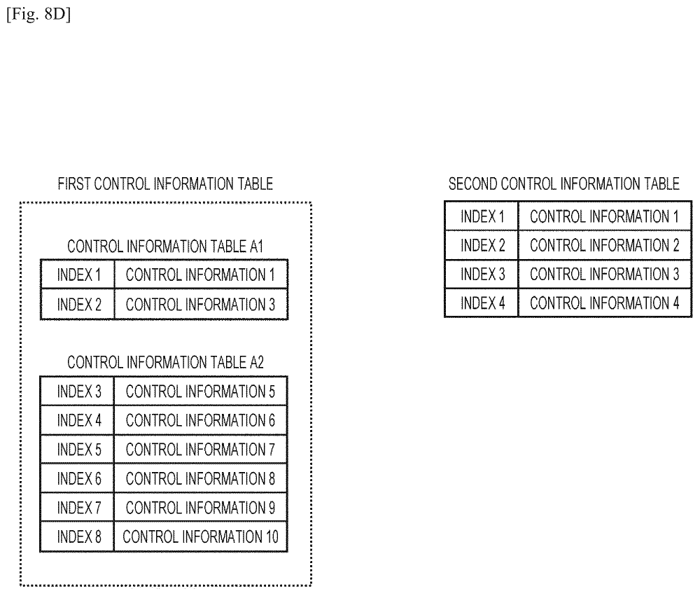

In the embodiment of FIG. 8A, the first control information table includes all the control information included in the second control information table, and new control information is added. In the embodiment of FIG. 8B, the first control information table includes a part of the control information included in the second control information table, and new control information is added.

In the embodiment of FIG. 8C, the first control information table is configured by combining the same control information table A1 as the second control information table and a new control information table A2.

That is, the first control information table in FIG. 8C includes all the control information included in the second control information table and new control information is added similarly to the first control information table in FIG. 8A, but the second control information table is referred to.

In the embodiment of FIG. 8D, the first control information table includes a control information table A1 and a control information table A2. That is, the first control information table in FIG. 8D includes a part of the control information included in the second control information table and new control information, similarly to the first control information table in FIG. 8B, but includes two control information tables.

### Second Example

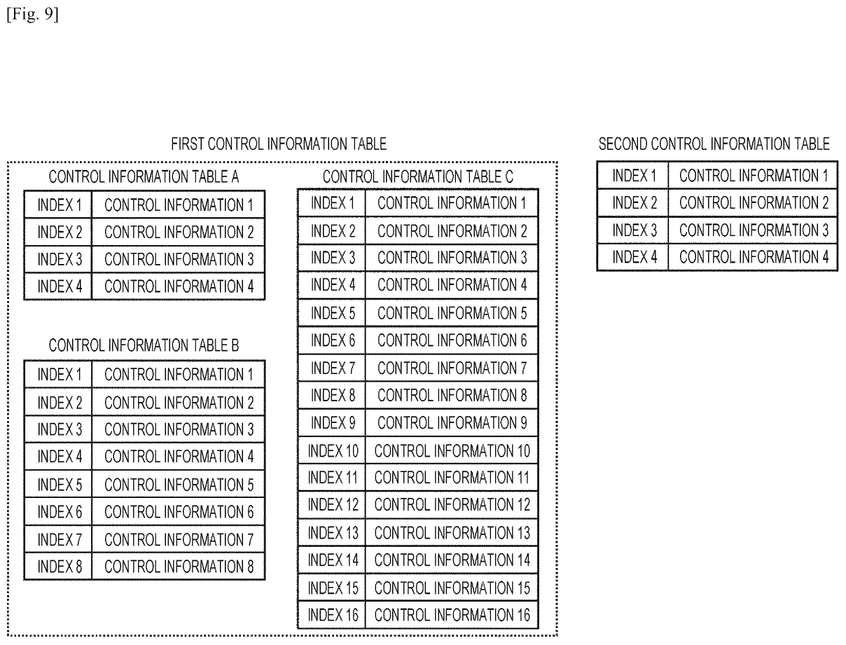

In the embodiment of FIG. 9, the first control information table includes the same control information table A as the second control information table and new control information tables B and C including all the control information included in the second control information table, and the plurality of control information tables are switched and referred to.

### Third Example

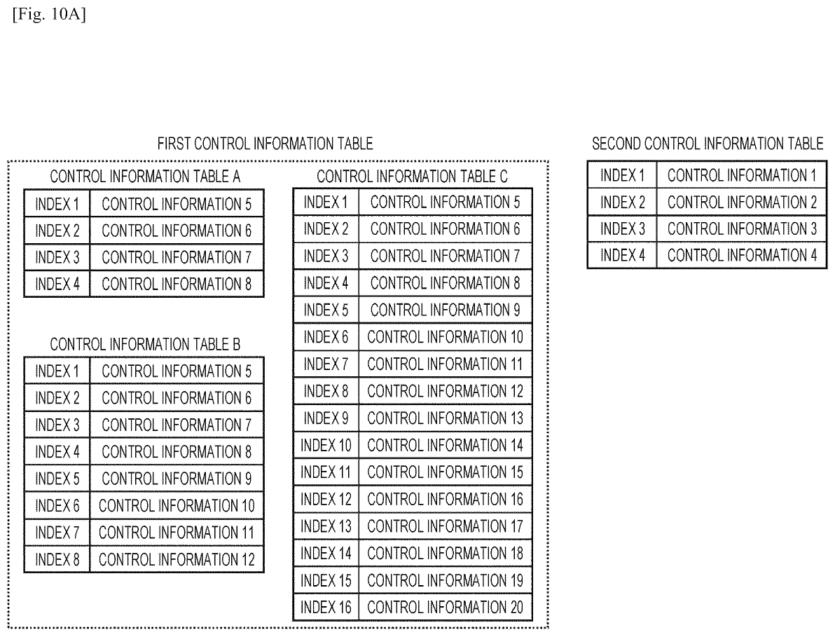

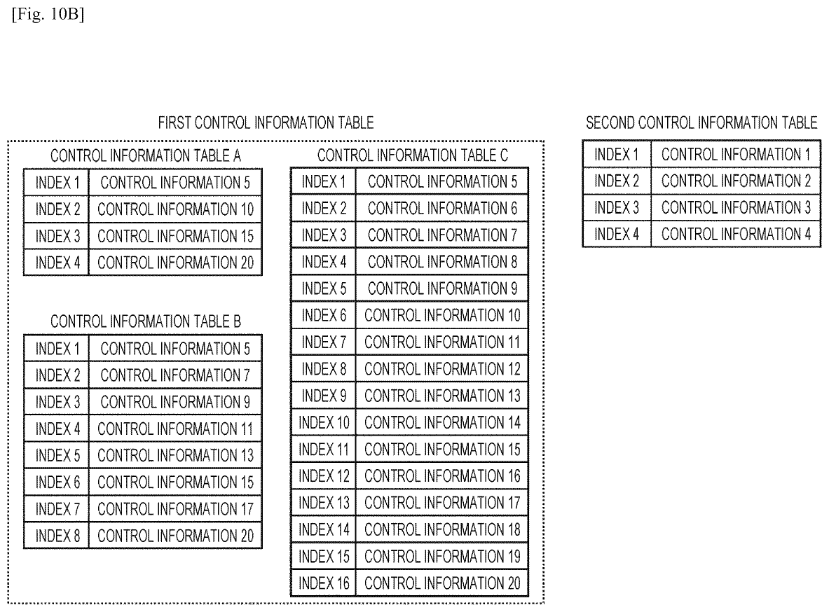

In the embodiment of FIG. 10A, the first control information table includes new control information tables A to C different from the second control information table, and the plurality of control information tables are switched and referred to.

In the example of FIG. 10B, the first control information table includes new control information tables A to C different from the second control information table, and based on the control information table C having the largest size, the control information tables A and B having sizes smaller than the control information table Care generated by extracting a part of the control information included in the control information table C, and the plurality of control information tables are switched and referred to.

In the first to third examples described above, the control information associated with each index may be determined in advance as static control information, or may be determined semi-statically by control information (different from the control information included in the control information table) exchanged between the terminal device 40 and the base station 20. In addition, some pieces of control information may be reserved values such as Reserved or dynamic setting values such as Flexible. In this case, the dynamic setting value such as Flexible may be dynamically determined by the control information (different from the control information included in the control information table) exchanged between the terminal device 40 and the base station 20, or may be dynamically determined in the course of learning of the AI/ML model.

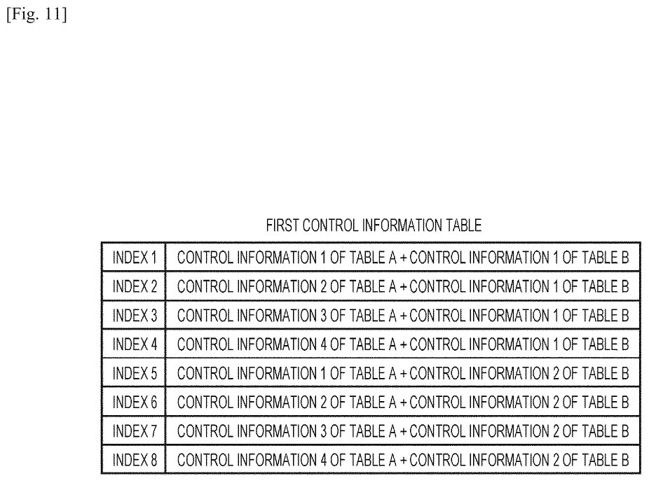

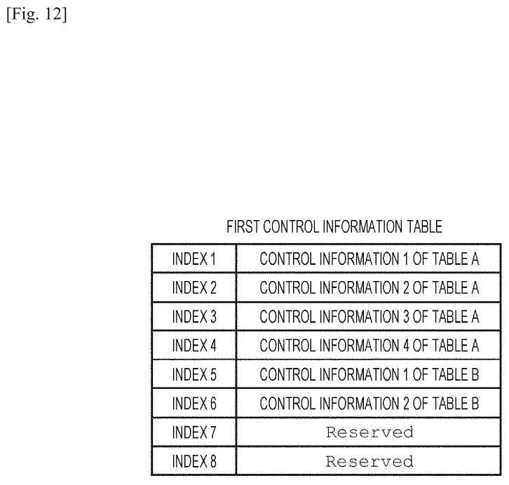

In the first to third examples, as illustrated in FIG. 11, each piece of control information included in the first control information table may be a combination of two or more types of control information. As illustrated in FIG. 12, the first control information table may include two or more types of control information.

### (Details of Processing of Radio Communication System)

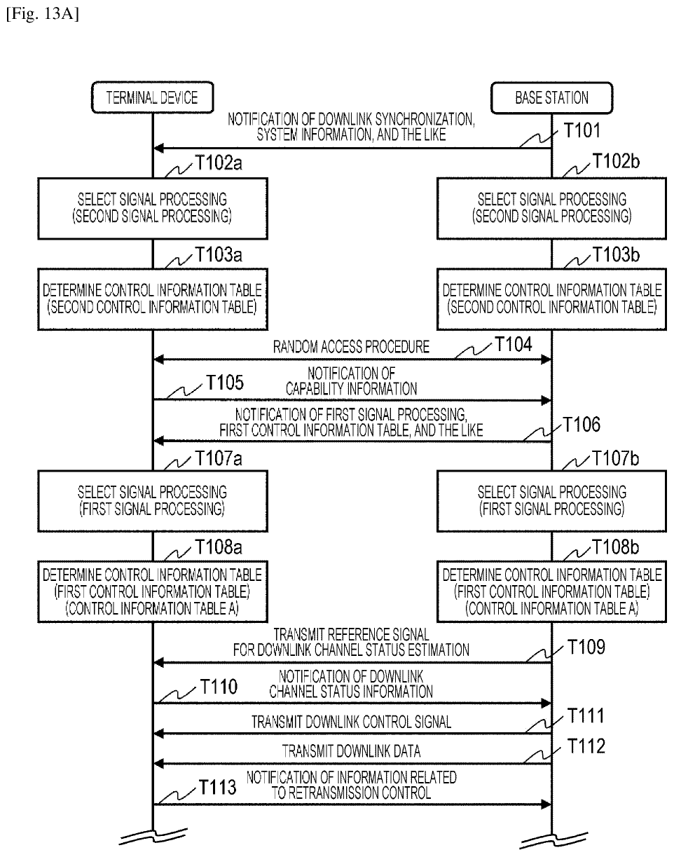

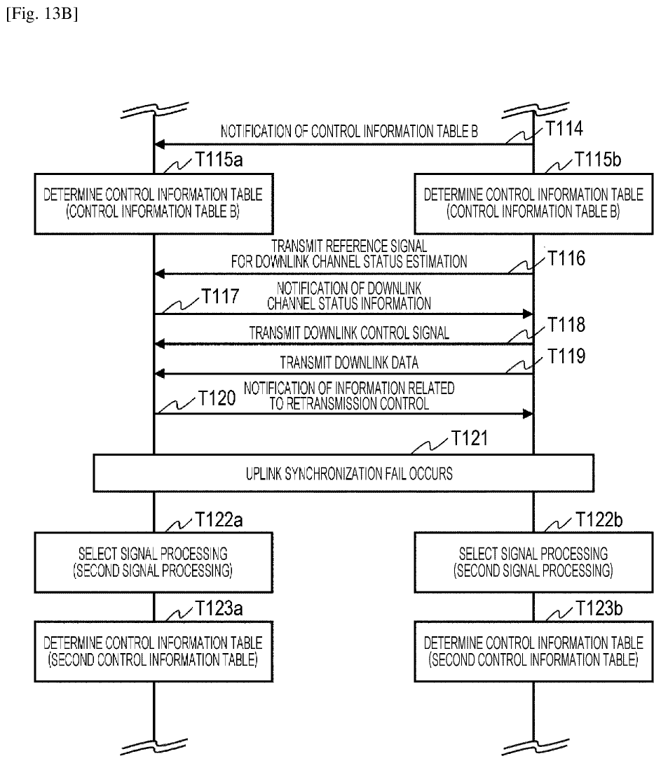

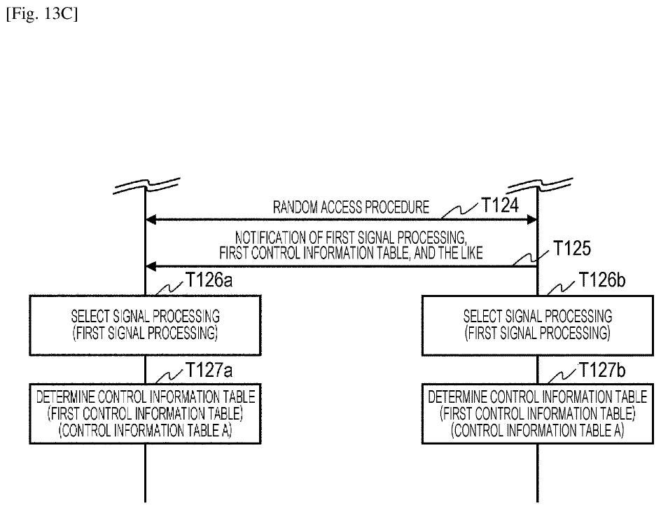

Hereinafter, details of processing in the radio communication system 1 according to the first embodiment will be described with reference to a sequence diagram of FIG. 13. However, in the sequence diagram of FIG. 13, it is assumed that the AI/ML model included in the first encoder 43 of the terminal device 40 and the AI/ML model included in the first decoder 23 of the base station 20 have been sufficiently learned in advance. In addition, it is assumed that a first control information table (control information table A, control information table B, and control information table C) and a second control information table illustrated in FIG. 9 are stored in advance in the storage unit 42 of the terminal device 40 and the storage unit 22 of the base station 20.

First, the transmitter 211 of the base station 20 transmits downlink synchronization, system information, and the like to the terminal device 40 (T101). The system information includes a notification to select second signal processing that does not use the AI/ML model and a notification to refer to the second control information table.

When the above system information is received by the receiver 412 of the terminal device 40, the control unit 45 of the terminal device 40 selects or determines to perform the second signal processing that does not use the AI/ML model (T102a). As described above, the second encoder 44 is used when the second signal processing is performed. Further, the control unit 45 of the terminal device 40 determines to refer to the second control information table (T103a).

Similarly, the control unit 25 of the base station 20, which is the transmission source of the system information, selects or determines to perform the second signal processing that does not use the AI/ML model (T102b). As described above, the second decoder 24 is used when the second signal processing is performed. Further, the control unit 25 of the base station 20 determines to refer to the second control information table (T103b).

After the random access procedure is performed between the terminal device 40 and the base station 20 (T104), the transmitter 411 of the terminal device 40 notifies the base station 20 of capability information of the terminal including the capability information of the first signal processing that uses the AI/ML model (T105). The transmitter 211 of the base station 20 that has received the notification transmits, to the terminal device 40, a notification to select the first signal processing, a notification to refer to the first control information table, and a notification to refer to the control information table A among the plurality of control information tables included in the first control information table (T106).

When the above notification is received by the receiver 412 of the terminal device 40, the control unit 45 of the terminal device 40 selects or determines to perform the first signal processing that uses the AI/ML model (T107a). As described above, the first encoder 43 is used when the first signal processing is performed. Further, the control unit 45 of the terminal device 40 determines to refer to the control information table A included in the first control information table (T108a).

Similarly, the control unit 25 of the base station 20, which is the transmission source of the above notification, selects or determines to perform the first signal processing that uses the AI/ML model (T107b). As described above, the first decoder 23 is used when the first signal processing is performed. Further, the control unit 25 of the base station 20 determines to refer to the control information table A included in the first control information table (T108b).

The transmitter 211 of the base station 20 transmits a reference signal for downlink channel status estimation, for example, a CSI-RS, to the terminal device 40 (T109). The transmitter 411 of the terminal device 40, that has received this, notifies terminal device 40 of downlink channel status information, for example, CQI, RI, PMI, or the like (T110).

The transmitter 211 of the base station 20 transmits downlink control information such as DCI to the terminal device 40 (T111). The downlink control information may include dynamic notification related to the technology according to the present disclosure, for example, notification to switch a control information table to be referred to. The transmitter 211 of the base station transmits the downlink data to the terminal device 40 by, for example, PDSCH or the like (T112). The transmitter 411 of the terminal device 40 that has received this information transmits information related to retransmission control, for example, ACK or NACK to the base station 20 (T113).

The transmitter 211 of the base station 20 transmits the notification to refer to control information table B included in the first control information table to terminal device 40 (T114). Upon receiving this, the control unit 45 of the terminal device 40 determines to stop referring to the control information table A included in the first control information table, and refer to the control information table B included in the first control information table (T115a).

Similarly, the control unit 25 of the base station 20, which is the transmission source of the notification, determines to stop referring to the control information table A included in the first control information table and refer to the control information table B included in the first control information table (T115b).

The transmitter 211 of the base station 20 transmits a reference signal for downlink channel status estimation, for example, a CSI-RS, to the terminal device 40 (T116). The transmitter 411 of the terminal device 40, that has received this, notifies terminal device 40 of downlink channel status information, for example, CQI, RI, PMI, or the like (T117).

The transmitter 211 of the base station 20 transmits downlink control information such as DCI to the terminal device 40 (T118). The downlink control information may include dynamic notification related to the technology according to the present disclosure, for example, notification to switch a control information table to be referred to. The transmitter 211 of the base station transmits the downlink data to the terminal device 40 by, for example, PDSCH or the like (T119). The transmitter 411 of the terminal device 40 that has received this information transmits information related to retransmission control, for example, ACK or NACK to the base station 20 (T120).

In step T121, when the uplink synchronization fail occurs, the control unit 45 of the terminal device 40 selects or determines again to perform the second signal processing that does not use the AI/ML model (T122a). Further, the control unit 45 of the terminal device 40 determines to refer to the second control information table (T123a). Similarly, the control unit 25 of the base station 20 selects or determines again to perform the second signal processing that does not use the AI/ML model (T122b). Further, the control unit 25 of the base station 20 determines to refer to the second control information table (T123b).

After the random access procedure is performed between the terminal device 40 and the base station 20 (T124), the transmitter 211 of the base station 20 transmits, to the terminal device 40, the notification to set the first signal processing, the notification to refer to the first control information table, and the notification to refer to the control information table A among the plurality of control information tables included in the first control information table (T125).

When the above notification is received by the receiver 412 of the terminal device 40, the control unit 45 of the terminal device 40 selects or determines to perform the first signal processing that uses the AI/ML model (T126a). Further, the control unit 45 of the terminal device 40 determines to refer to the control information table A included in the first control information table (T127a).

Similarly, the control unit 25 of the base station 20, which is the transmission source of the above notification, selects or determines to perform the first signal processing that uses the AI/ML model (T126b). Further, the control unit 25 of the base station 20 determines to refer to the control information table A included in the first control information table (T127b).

As described above, in the radio communication system 1 according to the first embodiment of the present disclosure, the terminal device 40 on the transmission side includes the first encoder 43 having the function of performing the first signal processing that uses the AI/ML model and the second encoder 44 having the function of performing the second signal processing that does not use the AI/ML model. The control unit 45 of the terminal device 40 selects or determines which one of the first signal processing and the second signal processing is to be performed, and determines which one of the first encoder 43 and the second encoder 44 is to be used on the basis of the selection result or the determination result.

Similarly, the base station 20 on the reception side includes the first decoder 23 having a function of performing first signal processing that uses the AI/ML model and the second decoder 24 having a function of performing second signal processing that does not use the AI/ML model. The control unit 25 of the base station 20 selects or determines which one of the first signal processing and the second signal processing is to be performed, and determines which one of the first decoder and the second decoder is to be used on the basis of the selection result or the determination result.

With the above feature, in the radio communication system according to the first embodiment of the present disclosure, both the signal processing used for the AI/ML model and the signal processing that does not use the AI/ML model can be performed.

In one example, the terminal device 40 on the transmission side transmits capability information of the first signal processing to the base station 20 on the reception side. The control unit 25 of the base station 20 selects or determines which one of the first signal processing and the second signal processing is to be performed on the basis of the received capability information. The control unit 45 of the terminal device 40 may select or determine which one of the first signal processing and the second signal processing is to be performed on the basis of the capability information transmitted by itself, or a selection result or a determination result regarding which one of the first signal processing and the second signal processing is to be performed may be notified from the base station 20 to the terminal device 40, and the control unit 45 of the terminal device 40 may determine which one of the first signal processing and the second signal processing is to be performed on the basis of the notified selection result or determination result. With such a feature, when the first signal processing that uses the AI/ML model can be performed, this can be utilized.

In another example, the base station 20 on the reception side transmits, to the terminal device 40 on the transmitting side, an explicit notification as to which one of first signal processing and second signal processing is to be performed. The control unit 45 of the terminal device 40 selects or determines which one of the first signal processing and the second signal processing is to be performed on the basis of the received explicit notification. The control unit 25 of the base station 20 selects or determines which one of the first signal processing and the second signal processing is to be performed on the basis of the explicit notification transmitted by itself. With such a feature, it is possible to finely and properly use the first signal processing that uses the AI/ML model and the second signal processing that does not use the AI/ML model.

In still another example, the control unit 45 of the terminal device 40 on the transmission side selects or determines which one of the first signal processing and the second signal processing is to be performed on the basis of a determination condition (in other words, implicit notification) set in advance or dynamically. Similarly, the control unit 25 of the base station 20 on the reception side selects or determines which one of the first signal processing and the second signal processing is to be performed on the basis of a determination condition set in advance or dynamically. With such a feature, it is possible to appropriately select or determine which one of the first signal processing and the second signal processing is to be performed without explicitly exchanging information between the transmission side and the reception side.

In addition, the terminal device 40 on the transmission side and the base station 20 on the reception side store a first control information table and a second control information table including one or a plurality of pieces of indexed control information. The first control information table is referred to by the first encoder 43 and the first decoder 23 when performing the first signal processing. The second control information table is referred to by the second encoder 44 and the second decoder 24 when performing the second signal processing.

In one example, the control unit 45 of the terminal device 40 and the control unit 25 of the base station 20 determine to refer to the first control information table when performing the first signal processing, and determine to refer to the second control information table when performing the second signal processing. With such a feature, the first control information table or the second control information table can be appropriately switched in conjunction with the execution of the first signal processing or the second signal processing.

In another example, the base station 20 on the reception side transmits, to the terminal device 40 on the transmitting side, an explicit notification as to which one of the first control information table and the second control information table is to be referred to. The control unit 45 of the terminal device 40 determines which one of the first control information table and the second control information table is to be referred to on the basis of the received explicit notification. The control unit 25 of the base station 20 determines which one of the first control information table and the second control information table is to be referred to on the basis of the explicit notification transmitted by itself. With such a feature, it is possible to finely switch between the first control information table and the second control information table.

In still another example, the control unit 45 of the terminal device 40 and the control unit 25 of the base station 20 determine which one of the first control information table and the second control information table is to be referred to on the basis of a determination condition set in advance or dynamically. With such a feature, it is possible to appropriately switch between the first control information table and the second control information table without explicitly exchanging information between the transmission side and the reception side.

Note that the technology according to the present disclosure is not limited to a specific standard, and the exemplified setting may be appropriately changed. Note that each of the above-described embodiments illustrates an example for embodying the technology according to the present disclosure, and the technology according to the present disclosure can be implemented in other various forms. For example, various modifications, substitutions, omissions, or combinations thereof can be made without departing from the gist of the present disclosure. Such modifications, substitutions, omissions, combinations, or the like are also included in the technology described in the claims and the equivalent scope thereof, as well as included in the scope of the present disclosure.

Furthermore, the procedure of the processing described in the present disclosure may be regarded as a method having a series of these procedures. Alternatively, it may be regarded as a program for causing a computer to perform the series of procedures or a recording medium storing the program. Furthermore, the processing described above may be executed by a processor such as a CPU of a computer. Furthermore, the type of the recording medium does not affect the embodiment of the present disclosure, and thus is not particularly limited.

Note that each component illustrated in FIGS. 2 to 6 in the present disclosure may be realized by software or hardware. For example, each component may be a software module realized by software such as a microprogram, and each component may be realized by a processor executing the software module. Alternatively, each component may be realized by a circuit block on a semiconductor chip (die), for example, an integrated circuit such as an application specific integrated circuit (ASIC) or a field programmable gate array (FPGA). In addition, the number of components and the number of pieces of hardware for realizing the components may not coincide with each other. For example, one processor or circuit may implement a plurality of components. Conversely, one component may be realized by a plurality of processors or circuits.

Note that the type of the processor described in the present disclosure is not limited. For example, it may be a CPU, a micro processing unit (MPU), a graphics processing unit (GPU), or the like.

Furthermore, the present disclosure can also have the following configurations.

(1)

### (Transmission Device)

A transmission device including:
a first encoder configured to have a function of performing first signal processing that uses an AI/ML model and generating a second bit sequence or symbol sequence from the first bit sequence or symbol sequence;
a second encoder configured to have a function of performing second signal processing that does not use the AI/ML model and generating a third bit sequence or symbol sequence from the first bit sequence or symbol sequence;
a first transmitter configured to transmit the second bit sequence or symbol sequence or the third bit sequence or symbol sequence; and
a first control unit configured to select or determine which one of the first signal processing and the second signal processing is to be performed, and determine which one of the first encoder and the second encoder is to be used on the basis of a selection result or determination result.
   (2)

### (Capability Information No. 1: Signal Processing)

The transmission device according to (1), further including:
a first transmitter configured to transmit capability information of the first signal processing, in which
the first control unit selects or determines which one of the first signal processing and the second signal processing is to be performed on a basis of the capability information.
   (3)

### (Capability Information No. 2: Signal Processing)

The transmission device according to (1), further including:
a first transmitter configured to transmit capability information of the first signal processing; and
a first receiver configured to receive a selection result or a determination result as to which one of the first signal processing and the second signal processing is to be performed, in which
the first control unit selects or determines which one of the first signal processing and the second signal processing is to be performed on a basis of the selection result or the determination result.
   (4)

### (Explicit Notification: Signal Processing)

The transmission device according to (1), further including:
a first receiver configured to receive an explicit notification as to which one of the first signal processing and the second signal processing is to be performed, in which the first control unit selects or determines which one of the first signal processing and the second signal processing is to be performed on a basis of the explicit notification.
   (5)

### (Determination Condition Set in Advance or Dynamically: Signal Processing)

The transmission device according to (1), in which the first control unit selects or determines which one of the first signal processing and the second signal processing is to be performed on a basis of a determination condition set in advance or dynamically.

(6)
(Interlocking with Signal Processing: Control Information Table)

The transmission device according to any one of (1) to (5), further including: a first control information table and a second control information table configured to include one or more pieces of indexed control information referred to by the first encoder or the second encoder during the first signal processing or the second signal processing, in which the first encoder or the second encoder specifies the control information included in the first control information table or the second control information table by the index, and the first control unit determines to refer to the first control information table when the first signal processing is performed, and determines to refer to the second control information table when the second signal processing is performed.

(7)

### (Explicit Notification: Control Information Table)

The transmission device according to any one of (1) to (5), further including:
a first control information table and a second control information table configured to include one or more pieces of indexed control information referred to by the first encoder or the second encoder during the first signal processing or the second signal processing; and
a first receiver configured to receive an explicit notification as to which one of the first control information table and the second control information table is to be referred to, in which
the first encoder or the second encoder specifies the control information included in the first control information table or the second control information table by the index, and
the first control unit determines which one of the first control information table and the second control information table is to be referred to on a basis of the explicit notification.
   (8)

### (Determination Condition Set in Advance or Dynamically: Control Information Table)

The transmission device according to any one of (1) to (5), further including: a first control information table and a second control information table configured to include one or more pieces of indexed control information referred to by the first encoder or the second encoder during the first signal processing or the second signal processing, in which the first encoder or the second encoder specifies the control information included in the first control information table or the second control information table by the index, and the first control unit determines which one of the first control information table and the second control information table is to be referred to on a basis of a determination condition set in advance or dynamically.

(9)

### (Reception Device)

A reception device including:
a first decoder configured to have a function of performing first signal processing that uses an AI/ML model and restoring a first bit sequence or symbol sequence from a second bit sequence or symbol sequence;
a second decoder configured to have a function of performing second signal processing that does not use the AI/ML model and restoring a first bit sequence or symbol sequence from a third bit sequence or symbol sequence;
a second receiver configured to receive the second bit sequence or symbol sequence or the third bit sequence or symbol sequence; and
a second control unit configured to select or determine which one of the first signal processing and the second signal processing is to be performed, and determine which one of the first decoder and the second decoder is to be used on a basis of the selection result or the determination result.
   (10)

### (Capability Information No. 1: Signal Processing)

The reception device according to (9), further including:
a second receiver configured to receive capability information of the first signal processing, in which the second control unit selects or determines which one of the first signal processing and the second signal processing is to be performed on a basis of the capability information.
   (11)

### (Capability Information No. 2: Signal Processing)

The reception device according to (9), further including:
a second receiver configured to receive capability information of the first signal processing; and
a first transmitter configured to transmit a selection result or a determination result as to which one of the first signal processing and the second signal processing is to be performed, in which
the second control unit selects or determines which one of the first signal processing and the second signal processing is to be performed on a basis of the capability information, and transmits the selection result or the determination result via the first transmitter.
   (12)

### (Explicit Notification: Signal Processing)

The reception device according to (9), further including:
a second transmitter configured to transmit an explicit notification as to which one of the first signal processing and the second signal processing is to be performed, in which
the second control unit selects or determines which one of the first signal processing and the second signal processing is to be performed on a basis of the explicit notification.
   (13)

### (Determination Condition Set in Advance or Dynamically: Signal Processing)

The reception device according to (9), in which the second control unit selects or determines which one of the first signal processing and the second signal processing is to be performed on a basis of a determination condition set in advance or dynamically.

(14)

The reception device according to any one of (9) to (13), further including:
a first control information table and a second control information table configured to include one or more pieces of indexed control information referred to by the first encoder or the second encoder during the first signal processing or the second signal processing, in which
the first decoder or the second decoder specifies the control information included in the first control information table or the second control information table by the index, and the second control unit determines to refer to the first control information table when the first signal processing is performed, and determines to refer to the second control information table when the second signal processing is performed.
   (15)

### (Explicit Notification: Control Information Table)

The reception device according to any one of (9) to (13), further including: a first control information table and a second control information table configured to include one or more pieces of indexed control information referred to by the first encoder or the second encoder during the first signal processing or the second signal processing; and a second transmitter configured to transmit an explicit notification as to which one of the first control information table and the second control information table is to be referred to, in which the first decoder or the second decoder specifies the control information included in the first control information table or the second control information table by the index, and the second control unit determines which one of the first control information table and the second control information table is to be referred to on the basis of the explicit notification.

(16)

### (Determination Condition Set in Advance or Dynamically: Control Information Table)

The reception device according to any one of (9) to (13), further including: a first control information table and a second control information table configured to include one or more pieces of indexed control information referred to by the first encoder or the second encoder during the first signal processing or the second signal processing, in which
the first decoder or the second decoder specifies the control information included in the first control information table or the second control information table by the index, and the second control unit determines which one of the first control information table and the second control information table is to be referred to on the basis of a determination condition set in advance or dynamically.
   (17)

### (Transmission Method)

A transmission method including:
selecting or determining which one of first signal processing that uses an AI/ML model and second signal processing that does not use the AI/ML model is to be performed;
when performing the first signal processing, generating a second bit sequence or symbol sequence from a first bit sequence or symbol sequence by first encoding using the AI/ML model, and transmitting the second bit sequence or symbol sequence; and
when performing the second signal processing, generating a third bit sequence or symbol sequence from the first bit sequence or symbol sequence by second encoding that does not use the AI/ML model, and transmitting the third bit sequence or symbol sequence.
   (18)

### (Reception Method)

A reception method including:
selecting or determining which one of first signal processing that uses an AI/ML model and second signal processing that does not use the AI/ML model is to be performed;
when performing the first signal processing, receiving a second bit sequence or symbol sequence and restoring the first bit sequence or symbol sequence from the second bit sequence or symbol sequence by first decoding using the AI/ML model; and
when performing the second signal processing, receiving a third bit sequence or symbol sequence, and restoring the first bit sequence or symbol sequence from the third bit sequence or symbol sequence by second decoding that does not use the AI/ML model.

Furthermore, the present disclosure can also have the following configurations.

### (1A)

### (Transmission Device)

A transmission device including:
circuitry configured to:
   process a first bit sequence or symbol sequence with a first signal processing that uses an AI/ML model;
   generate a second bit sequence or symbol sequence from a result the first signal processing;
   process the first bit sequence or symbol sequence with a second signal processing that does not use an AI/ML model;
   generate a third bit sequence or symbol sequence from a result of the second signal processing; and
   select or determine whether to process the first bit sequence or symbol sequence with the first signal processing or the second signal processing; and
   a first transmitter configured to transmit the second bit sequence or symbol sequence or the third bit sequence or symbol sequence according to the selection or determination.

### (2A)

### (Capability Information No. 1: Signal Processing)

The transmission device according to (1), further including:
a first transmitter configured to transmit capability information of the first signal processing, and
circuitry further configured to select or determine which one of the first signal processing and the second signal processing is to be performed on a basis of the capability information.

### (3A)

### (Capability Information No. 2: Signal Processing)

The transmission device according to (1), further including:
a first transmitter further configured to transmit capability information of the first signal processing,
a transmission device comprises a first receiver configured to receive a selection result or a determination result as to which one of the first signal processing and the second signal processing is to be performed, and
circuitry configured to select or determine which one of the first signal processing and the second signal processing is to be performed on a basis of the selection result or the determination result.

### (4A)

### (Explicit Notification: Signal Processing)

The transmission device according to (1), further including:
a first receiver configured to receive an explicit notification as to which one of the first signal processing and the second signal processing is to be performed, in which the circuitry is configured to select or determine which one of the first signal processing and the second signal processing is to be performed on a basis of the explicit notification.

### (5A)

### (Determination Condition Set in Advance or Dynamically: Signal Processing)

The transmission device according to (1), in which the circuitry is configured to select or determine which one of the first signal processing and the second signal processing is to be performed on a basis of a determination condition set in advance or dynamically.

### (6A)

The transmission device according to any one of (1) to (5), in which the circuitry is further configured to:
specify control information included in a first control information table or a second control information table in which each of the first control information table and the second control information table include one or more pieces of indexed control information referred to by the circuitry during the first signal processing or the second signal processing; and
use, for the first signal processing, the control information included in the first control information table when the first signal processing is performed, and to use, for the second signal processing, the control information included in the second control information table when the second signal processing is performed.

### (7A)

### (Explicit Notification: Control Information Table)

The transmission device according to any one of (1) to (5), further including: a receiver configured to receive an explicit notification as to which one of a first control information table and a second control information table is to be referred to, in which
each of the first control information table and the second control information table include one or more pieces of indexed control information referred to by the circuitry during the first signal processing or the second signal processing, and
the circuitry is further configured to determine which one of the first control information table and the second control information table is to be referred to on a basis of the explicit notification.

### (8A)

### (Determination Condition Set in Advance or Dynamically: Control Information Table)

The transmission device according to any one of (1) to (5), further including: circuitry further is configured to determine which one of a first control information table and a second control information table is to be referred to on a basis of a determination condition set in advance or dynamically, in which each of the first control information table and a second control information table include one or more pieces of indexed control information referred to by the circuitry during the first signal processing or the second signal processing.

### (9A)

### (Reception Device)

A reception device including:
a receiver configured to receive a second bit sequence or symbol sequence or a third bit sequence or symbol sequence; and circuitry configured to:
   process the second bit sequence or symbol sequence with a first signal processing that uses an AI/ML model;
   restore a first bit sequence or symbol sequence from a result the first signal processing;
   process the third bit sequence or symbol sequence with a second signal processing that does not use an AI/ML model;
   restore the first bit sequence or symbol sequence from a result of the second signal processing; and
   select or determine which of the processing and restoring of the second bit sequence or symbol sequence with the first signal processing or third bit sequence or symbol sequence with the second signal processing is to be performed.

### (10A)

### (Capability Information No. 1: Signal Processing)

The reception device according to (9), further including:
a receiver configured to receive capability information of the first signal processing; and
circuitry configured to select or determine which of the processing and restoring of the second bit sequence or symbol sequence with the first signal processing or third bit sequence or symbol sequence with the second signal processing is to be performed on a basis of the capability information.

### (11A)

### (Capability Information No. 2: Signal Processing)

The reception device according to (9), further including:
a receiver configured to receive capability information of the first signal processing;
a transmitter configured to transmit a selection result or a determination result as to which of the processing and restoring of the second bit sequence or symbol sequence with the first signal processing or third bit sequence or symbol sequence with the second signal processing is to be performed; and
circuitry configured to select or determine which of the processing and restoring of the second bit sequence or symbol sequence with the first signal processing or third bit sequence or symbol sequence with the second signal processing is to be performed on a basis of the capability information and transmit the selection result or the determination result via the transmitter.

### (12A)

### (Explicit Notification: Signal Processing)

The reception device according to (9), further including:
a transmitter configured to transmit an explicit notification as to which of the processing and restoring of the second bit sequence or symbol sequence with the first signal processing or third bit sequence or symbol sequence with the second signal processing is to be performed; and
circuitry configured to select or determine which of the processing and restoring of the second bit sequence or symbol sequence with the first signal processing or third bit sequence or symbol sequence with the second signal processing is to be performed on a basis of the explicit notification.

### (13A)

### (Determination Condition Set in Advance or Dynamically: Signal Processing)

The reception device according to (9), further comprising:
circuitry configured to select or determine which of the processing and restoring of the second bit sequence or symbol sequence with the first signal processing or third bit sequence or symbol sequence with the second signal processing is to be performed on a basis of a determination condition set in advance or dynamically.

### (14A)

(Interlocking with Signal Processing: Control Information Table)

The reception device according to any one of (9) to (13), further including: circuitry configured to:
specify control information included in a first control information table or a second control information table in which each of the first control information table and the second control information table include one or more pieces of indexed control information referred to by the circuitry during the first signal processing or the second signal processing; and
use, for the first signal processing, the control information included in the first control information table when the first signal processing is performed, and to use, for the second signal processing, the control information included in the second control information table when the second signal processing is performed.

### (15A)

### (Explicit Notification: Control Information Table)

The reception device according to any one of (9) to (13), further including: a transmitter configured to transmit an explicit notification as to which one of a first control information table and a second control information table is to be referred to, wherein each of the first control information table and the second control information table include one or more pieces of indexed control information referred to by the circuitry during the first signal processing or the second signal processing; and circuitry configured to determine which one of the first control information table and the second control information table is to be referred to on a basis of the explicit notification.

### (16A)

### (Determination Condition Set in Advance or Dynamically: Control Information Table)

The reception device according to any one of (9) to (13), further including: circuitry configured to determine which one of a first control information table and a second control information table is to be referred to on a basis of a determination condition set in advance or dynamically, in which each of the first control information table and a second control information table include one or more pieces of indexed control information referred to by the circuitry during the first signal processing or the second signal processing.

### (17A)

### (Transmission Method)

A transmission method including:
processing a first bit sequence or symbol sequence with a first signal processing that uses an AI/ML model;
generating a second bit sequence or symbol sequence from a result the first signal processing;
processing the first bit sequence or symbol sequence with a second signal processing that does not use an AI/ML model;
generating a third bit sequence or symbol sequence from a result of the second signal processing;
selecting or determine whether to process the first bit sequence or symbol sequence with the first signal processing or the second signal processing; and
transmitting the second bit sequence or symbol sequence or the third bit sequence or symbol sequence according to the selection or determination.

### (18A)

### (Reception Method)

A reception method including:
receiving a second bit sequence or symbol sequence or a third bit sequence or symbol sequence;
processing the second bit sequence or symbol sequence with a first signal processing that uses an AI/ML model;
restoring a first bit sequence or symbol sequence from a result the first signal processing;
processing the third bit sequence or symbol sequence with a second signal processing that does not use an AI/ML model;
restoring the first bit sequence or symbol sequence from a result of the second signal processing; and
selecting or determining which of the processing and restoring of the second bit sequence or symbol sequence with the first signal processing or third bit sequence or symbol sequence with the second signal processing is to be performed.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 Radio communication system
10 Management device
11 Communication unit
12 Storage unit
13 Control unit
20 Base station (reception device)
21 Radio communication unit
211 Transmitter (second transmitter)
212 Receiver (second receiver)
213 Antenna
22 Storage unit
23 First decoder
24 Second decoder
25 Control unit (second control unit)
30 Relay station (reception device)
31 Radio communication unit
311 Transmitter (second transmitter)
312 Receiver (second receiver)
313 Antenna
32 Storage unit
33 First decoder
34 Second decoder
35 Control unit (second control unit)
40 Terminal device (transmission device)
41 Radio communication unit
411 Transmitter (first transmitter)
412 Receiver (first receiver)
413 Antenna
42 Storage unit
43 First decoder
44 Second decoder
45 Control unit (first control unit)

1. A transmission device comprising:
circuitry configured to:
process a first bit sequence or symbol sequence with a first signal processing that uses an AI/ML model;
generate a second bit sequence or symbol sequence from a result the first signal processing;
process the first bit sequence or symbol sequence with a second signal processing that does not use an AI/ML model;
generate a third bit sequence or symbol sequence from a result of the second signal processing; and
select or determine whether to process the first bit sequence or symbol sequence with the first signal processing or the second signal processing; and
a first transmitter configured to transmit the second bit sequence or symbol sequence or the third bit sequence or symbol sequence according to the selection or determination.

2. The transmission device according to claim 1, wherein the first transmitter is further configured to transmit capability information of the first signal processing, and
wherein the circuitry is further configured to select or determine which one of the first signal processing and the second signal processing is to be performed on a basis of the capability information.

3. The transmission device according to claim 1, wherein the first transmitter is further configured to transmit capability information of the first signal processing,
wherein the transmission device further comprises a first receiver configured to receive a selection result or a determination result as to which one of the first signal processing and the second signal processing is to be performed, and
wherein the circuitry is configured to select or determine which one of the first signal processing and the second signal processing is to be performed on a basis of the selection result or the determination result.

4. The transmission device according to claim 1, further comprising:
a first receiver configured to receive an explicit notification as to which one of the first signal processing and the second signal processing is to be performed,
wherein the circuitry is configured to select or determine which one of the first signal processing and the second signal processing is to be performed on a basis of the explicit notification.

5. The transmission device according to claim 1, wherein the circuitry is configured to select or determine which one of the first signal processing and the second signal processing is to be performed on a basis of a determination condition set in advance or dynamically.

6. The transmission device according to claim 1, wherein the circuitry is further configured to:
specify control information included in a first control information table or a second control information table in which each of the first control information table and the second control information table include one or more pieces of indexed control information referred to by the circuitry during the first signal processing or the second signal processing; and
use, for the first signal processing, the control information included in the first control information table when the first signal processing is performed, and to use, for the second signal processing, the control information included in the second control information table when the second signal processing is performed.

7. The transmission device according to claim 1, further comprising:
a receiver configured to receive an explicit notification as to which one of a first control information table and a second control information table is to be referred to, wherein each of the first control information table and the second control information table include one or more pieces of indexed control information referred to by the circuitry during the first signal processing or the second signal processing, and
wherein the circuitry is further configured to determine which one of the first control information table and the second control information table is to be referred to on a basis of the explicit notification.

8. The transmission device according to claim 1, wherein the circuitry is further is configured to determine which one of a first control information table and a second control information table is to be referred to on a basis of a determination condition set in advance or dynamically,
wherein each of the first control information table and a second control information table include one or more pieces of indexed control information referred to by the circuitry during the first signal processing or the second signal processing.

9. A reception device comprising:
a receiver configured to receive a second bit sequence or symbol sequence or a third bit sequence or symbol sequence; and
circuitry configured to:
process the second bit sequence or symbol sequence with a first signal processing that uses an AI/ML model;
restore a first bit sequence or symbol sequence from a result the first signal processing;
process the third bit sequence or symbol sequence with a second signal processing that does not use an AI/ML model; and
restore the first bit sequence or symbol sequence from a result of the second signal processing;
wherein the circuitry is further configured to select or determine which of the processing and restoring of the second bit sequence or symbol sequence with the first signal processing or third bit sequence or symbol sequence with the second signal processing is to be performed.

10. The reception device according to claim 9, wherein the receiver is further configured to receive capability information of the first signal processing,
and wherein the circuitry is further configured to select or determine which of the processing and restoring of the second bit sequence or symbol sequence with the first signal processing or third bit sequence or symbol sequence with the second signal processing is to be performed on a basis of the capability information.

11. The reception device according to claim 9, wherein the receiver is further configured to receive capability information of the first signal processing,
wherein the reception device further comprises a transmitter configured to transmit a selection result or a determination result as to which of the processing and restoring of the second bit sequence or symbol sequence with the first signal processing or third bit sequence or symbol sequence with the second signal processing is to be performed, and wherein the circuitry is further configured to select or determine which of the processing and restoring of the second bit sequence or symbol sequence with the first signal processing or third bit sequence or symbol sequence with the second signal processing is to be performed on a basis of the capability information and transmit the selection result or the determination result via the transmitter.

12. The reception device according to claim 9, further comprising a transmitter configured to transmit an explicit notification as to which of the processing and restoring of the second bit sequence or symbol sequence with the first signal processing or third bit sequence or symbol sequence with the second signal processing is to be performed, wherein the circuitry is further configured to select or determine which of the processing and restoring of the second bit sequence or symbol sequence with the first signal processing or third bit sequence or symbol sequence with the second signal processing is to be performed on a basis of the explicit notification.

13. The reception device according to claim 9, wherein the circuitry is further configured to select or determine which of the processing and restoring of the second bit sequence or symbol sequence with the first signal processing or third bit sequence or symbol sequence with the second signal processing is to be performed on a basis of a determination condition set in advance or dynamically.

14. The reception device according to claim 9, wherein the circuitry is further configured to:
specify control information included in a first control information table or a second control information table in which each of the first control information table and the second control information table include one or more pieces of indexed control information referred to by the circuitry during the first signal processing or the second signal processing; and
use, for the first signal processing, the control information included in the first control information table when the first signal processing is performed, and to use, for the second signal processing, the control information included in the second control information table when the second signal processing is performed.

15. The reception device according to claim 9, further comprising:
a transmitter configured to transmit an explicit notification as to which one of a first control information table and a second control information table is to be referred to, wherein each of the first control information table and the second control information table include one or more pieces of indexed control information referred to by the circuitry during the first signal processing or the second signal processing, and
wherein the circuitry is further configured to determine which one of the first control information table and the second control information table is to be referred to on a basis of the explicit notification.

16. The reception device according to claim 9, wherein the circuitry is further is configured to determine which one of a first control information table and a second control information table is to be referred to on a basis of a determination condition set in advance or dynamically,
wherein each of the first control information table and a second control information table include one or more pieces of indexed control information referred to by the circuitry during the first signal processing or the second signal processing.

17. A transmission method comprising:
processing a first bit sequence or symbol sequence with a first signal processing that uses an AI/ML model;
generating a second bit sequence or symbol sequence from a result the first signal processing;
processing the first bit sequence or symbol sequence with a second signal processing that does not use an AI/ML model;
generating a third bit sequence or symbol sequence from a result of the second signal processing;
selecting or determine whether to process the first bit sequence or symbol sequence with the first signal processing or the second signal processing; and
transmitting the second bit sequence or symbol sequence or the third bit sequence or symbol sequence according to the selection or determination.

18. A reception method comprising:
receiving a second bit sequence or symbol sequence or a third bit sequence or symbol sequence;
processing the second bit sequence or symbol sequence with a first signal processing that uses an AI/ML model;
restoring a first bit sequence or symbol sequence from a result the first signal processing;
processing the third bit sequence or symbol sequence with a second signal processing that does not use an AI/ML model;
restoring the first bit sequence or symbol sequence from a result of the second signal processing; and
selecting or determining which of the processing and restoring of the second bit sequence or symbol sequence with the first signal processing or third bit sequence or symbol sequence with the second signal processing is to be performed.
